(19) United States
(12) Patent Application Publication
(10) Pub. No.: US 2006/0234101 A1
(43) Pub. Date: Oct. 19, 2006

(54) Solid electrolyte, electrode for fuel cell, film and electrode assembly, method for producing fuel cell and solid electrolyte

(75) Inventor: Masashi Kaneko, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/386,645

(22) Filed: Mar. 23, 2006

(30) Foreign Application Priority Data
Mar. 23, 2005 (JP) 084984/2005
Mar. 23, 2005 (JP) 084985/2005

(51) Int. Cl. H01M 8/10; C08J 5/20

(52) U.S. Cl. 429/33; 521/25; 429/314; 429/317

(57) ABSTRACT

A solid electrolyte including an aromatic polymer compound in which an acid residue bonds at least to an aromatic ring included in a main chain via a carbon-carbon double bond. The solid electrolyte has high ion conductive performance and high durability. The solid electrolyte has a high ion conductive performance and durability.

### BACKGROUND OF THE INVENTION

1. Field of the Invention

The present invention relates to a solid electrolyte, particularly to a solid electrolyte film having proton conductive performance, an electrode for a fuel cell, a film and electrode assembly, and a fuel cell.

2. Description of the Related Art

A compact size power source is preferable when it has a same output power. Among others, a fuel cell has been actively examined because it has such characteristics that it is quieter than an internal-combustion system such as engines and exhausts clean gas, and it has possibility of achieving a higher energy efficiency than an internal-combustion system.

In general, as a proton conductive material, a perfluorocarbon sulfonate film as represented by Nafion (registered trademark) is used. However, the proton conductivity thereof is not sufficient yet. But, increase in an amount of sulfonic acid group in the polymer structure for the purpose of enhancing the proton conductivity results in decrease in mechanical strength and solubilization in an aqueous solvent. Further, it has such a problem that it softens under high temperature conditions (for example, 100° C. or more) to result in decrease in the proton conductivity, which makes use of Nafion® difficult at high temperature regions (for example, 120-140° C. or more). In addition, there also remains such problems that a monomer to be used is relatively expensive and the complex production method pushes up the production cost.

Recently, there have been developed many examples of solid electrolytes using polymer material having a high rigidity. On the other hand, solid electrolytes using a resin material having a high solvent resistance among polymer materials have been studied for a long time. For example, JP-A-6-49202, JP-A-6-93114, JP-A-8-20716, JP-A-9-245818 and JP-A-10-21943 describe development of solid electrolytes composed mainly of a sulfonated polyetheretherketone-based compound, a sulfonated polysulfone-based compound or a sulfonated polyetherketone-based compound. However, in each case, a sulfonic acid group directly bonds to an aromatic ring included in the polymer main chain, there is such a problem that the sulfonic acid group is gradually detached due to a high operation temperature, resulting in lowering in battery performance. Further, since the sulfonic acid group bonds directly to the polymer main chain, distance between the main chain as a hydrophobic moiety and the sulfonic acid group as a hydrophilic moiety is short to lead to absorption of water molecules beyond necessity, thereby resulting in such a problem that a low introduction amount of the sulfonic acid group makes the compound soluble in an aqueous solvent.

In Japanese Patent No. 3607862, a solid electrolyte is manufactured by bonding a sulfonic acid group, via an alkyl group, to an aromatic ring of a polymer main chain synthesized by polycondensation. The method aims to enhance the proton conductivity and mechanical strength by bonding a sulfonic acid group with the main chain via a methylene chain and thus separating the hydrophobic moiety of the main chain from the hydrophilic moiety of a side chain having the sulfonic acid group with a relatively large distance. However, as it now stands in actual, since the reaction efficiency is very low, only a small amount of sulfonic acid groups are introduced and the hydrophilic moiety of the side chain having the sulfonic acid group is not sufficiently separated from the hydrophobic moiety of the main chain.

### SUMMARY OF THE INVENTION

An object of the present invention is to solve the aforementioned problems, and to provide a solid electrolyte having a high ion conductive performance and durability.

The present inventors found that, by employing a structure in which a sulfonic acid group bonding to a C═C double bond bonds to an aromatic ring via a covalent bond in place of the structure in which a sulfonic acid group bonds to an aromatic ring via an alkyl group, molecular structure is stabilized due to a resonance effect between the sulfonic acid group and the double bond and durability against detachment of the sulfonic acid group from the polymer structure to be able to inhibit deterioration of battery performance with use of a long period of time, thereby completing the invention. Specifically, the object was achieved according to the following means.

(1) A solid electrolyte comprising an aromatic polymer compound in which an acid residue bonds to an aromatic ring included in the main chain of the compound via a carbon-carbon double bond.

(2) The solid electrolyte according to (1), wherein the main chain of the aromatic polymer compound comprises at least one recurring structure represented by the following formula (1) or (4):
-R¹¹-X- (1)
-R¹⁴ (4)
wherein each of R¹¹ and R¹⁴ independently represents a group consisting of at least one linking group represented by the following formulae (5)-(24): 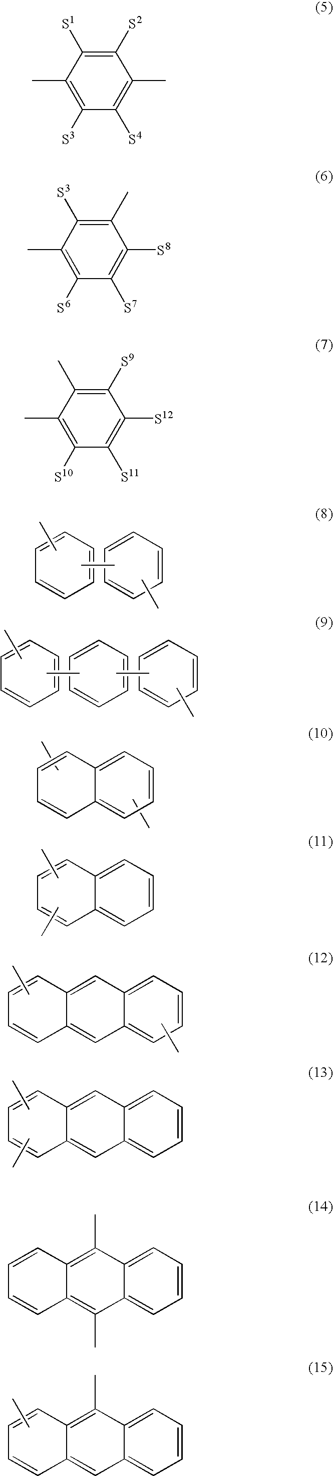 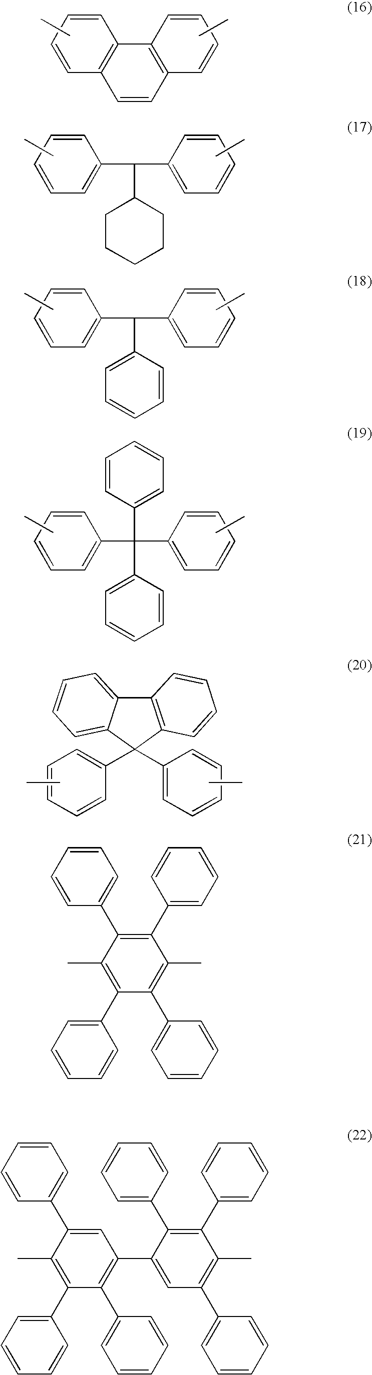 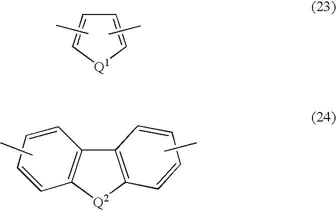
wherein each of S¹-S¹² in (5)-(7) independently represents a hydrogen atom or a substituent, Q¹ in (23) represents —O— or —S—, and Q² in (24) represents —O—, —CH₂—, —CO— or —NH₂—. X represents —C(R²⁵R^{2δ})—, —O—, —S—, —CO—, —SO— or —SO₂—, each of R²⁵ and R^{2δ} independently represents a hydrogen atom, an alkyl group, an alkenyl group, an aryl group or a halogen-substituted alkyl group.
(3) The solid electrolyte according to (1), wherein the aromatic polymer compound is a polyethersulfon-based compound, a polyetherethersulfone-based compound, a polyetheretherketone-based compound, a polyphenylenesulfide-based compound, a polyphenyleneether-based compound, a polysulfone-based compound, a polyetherketone-based compound, a polyimide-based compound or a polyetherimide-based compound.
(4) The solid electrolyte according to (1), wherein the main chain of the aromatic polymer compound comprises at least one recurring structure represented by any one of the following formulae (2-1)-(2-4): 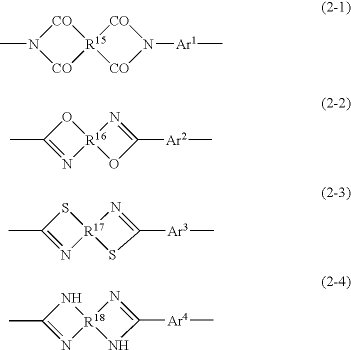
wherein each of R¹⁵-R¹⁸ independently represents a quadrivalent group having 6-36 carbon atoms, and forms a cyclic structure with adjacent 2 bonding groups. Each of Ar¹-Ar⁴ independently represents a divalent group having 6-24 carbon atoms.
(5) The solid electrolyte according to (1), wherein the main chain of the aromatic polymer compound comprises at least one recurring structure represented by any one of the following formulae (3-1)-(3-5): 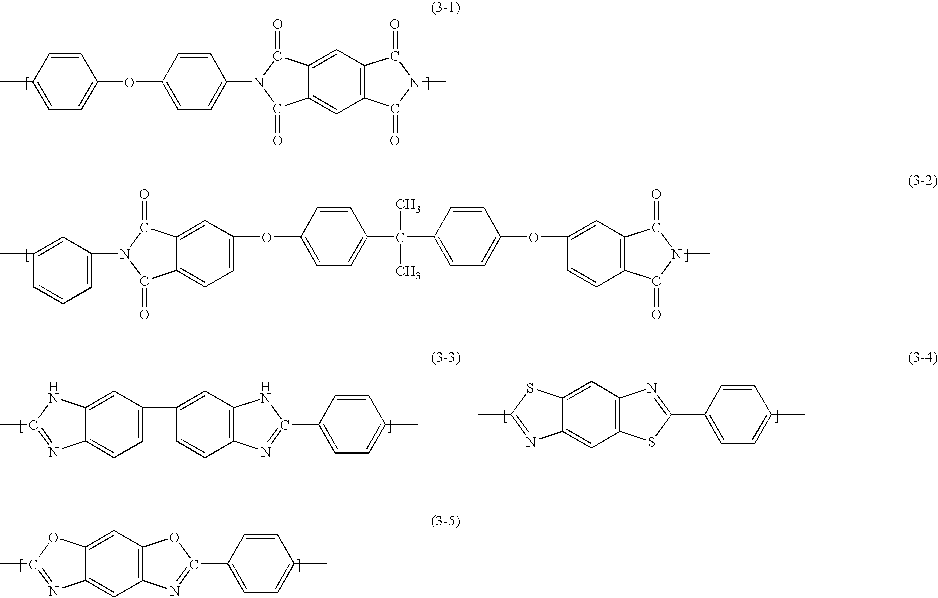
(6) The solid electrolyte according to any of (1)-(5), wherein the acid residue is a sulfonic acid group.
(7) The solid electrolyte according to any of (1)-(6) the aromatic polymer compound comprises a side chain represented by the following formula (A-2): 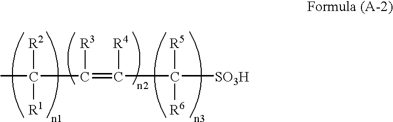
wherein each of R¹-R⁶ independently represents a hydrogen atom or a substituent, and two or more of R¹-R⁶ may bond to each other to form a ring. n1 represents 0 or an integer of 1-20, n2 represents an integer of 1-3, and n3 represents 0 or an integer of 1-10.
(8) The solid electrolyte according to any of (1)-(6) the aromatic polymer compound comprises a side chain represented by the following formula (A-2): 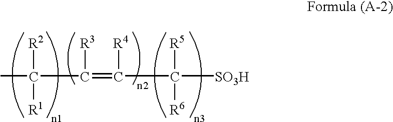
wherein each of R¹-R⁶ independently represents a hydrogen atom or a substituent, and two or more of R¹-R⁶ may bond to each other to form a ring. n1 represents 0 or an integer of 1-20, n2 represents an integer of 1-3, and n3 represents 0.
(9) The solid electrolyte according to any of (1)-(8) which is in the form of film.
(10) An electrode for a fuel cell comprising the solid electrolyte according to any of (1)-(9).
(11) A film and electrode assembly comprising a pair of electrodes and the solid electrolyte according to (9) sandwiched between the electrodes.
(12) A fuel cell comprising the film and electrode assembly according to (9).
(13) A solid electrolyte comprising an aromatic polymer compound having a main chain including an aromatic ring and a side chain bonding to the aromatic ring, in which a carbon atom at an α position of the side chain is bonded with at least one substituent as well as a sulfonic acid group.
(14) The solid electrolyte according to (13) wherein the main chain of the aromatic polymer compound comprises at least one recurring structure represented by the following formula (1) or (4):
-R¹¹-X- (1)
-R¹⁴ (4)
wherein each of R¹¹ and R¹⁴ independently represents a group consisting of at least one linking group represented by the following formulae (5)-(24): 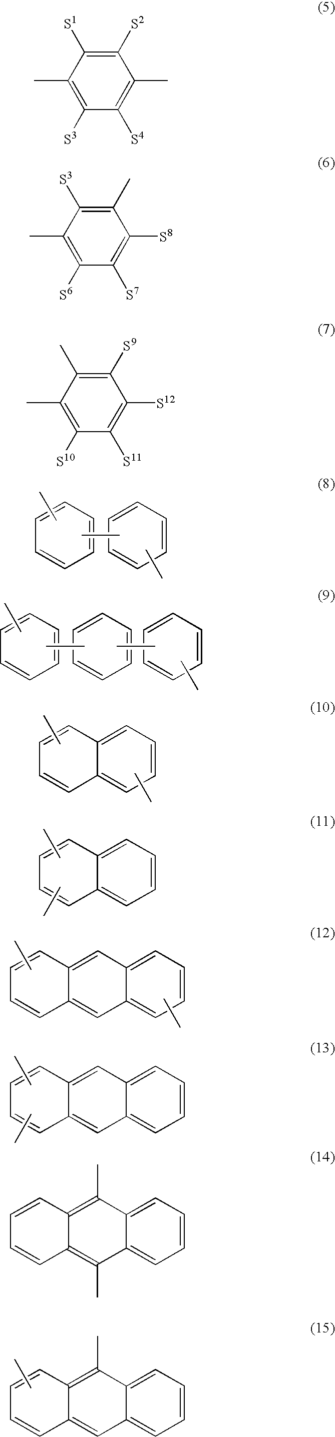 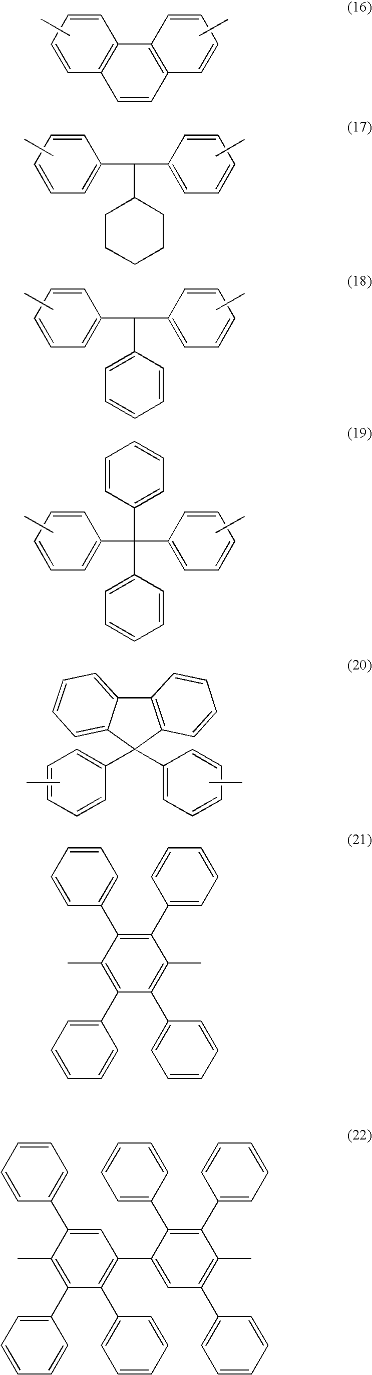 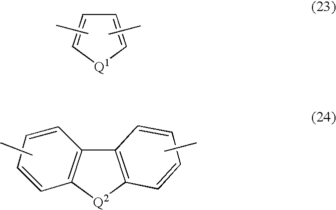
wherein each of S¹-S¹² in (5)-(7) independently represents a hydrogen atom or a substituent, Q¹ in (23) represents —O— or —S—, and Q² in (24) represents —O—, —CH₂—, —CO— or —NH₂—. X represents —C(R²⁵R²⁶)—, —O—, —S—, —CO—, —SO— or —SO₂—, and each of R²⁵ and R²⁶ independently represents a hydrogen atom, an alkyl group, an alkenyl group, an aryl group or a halogen-substituted alkyl group.
(15) The solid electrolyte according to (13), wherein the aromatic polymer compound is a polyethersulfon-based compound, a polyetherethersulfone-based compound, a polyetheretherketone-based compound, a polyphenylenesulfide-based compound, a polyphenyleneether-based compound, a polysulfone-based compound, a polyetherketone-based compound, a polyimide-based compound or a polyetherimide-based compound.
(16) The solid electrolyte according to (13), wherein the main chain of the aromatic polymer compound comprises at least one recurring structure represented by any one of the following formulae (2-1)-(2-4): 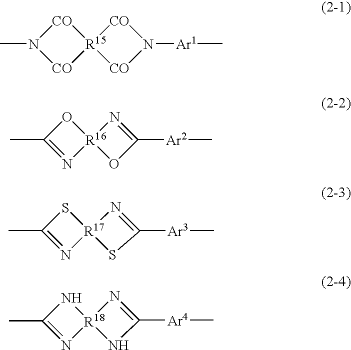
wherein each of R¹⁵-R¹⁸ independently represents a quadrivalent group having 6-36 carbon atoms, and forms a cyclic structure with adjacent 2 bonding groups. Each of Ar¹-Ar⁴ independently represents a divalent group having 6-24 carbon atoms.
(17) The solid electrolyte according to (13), wherein the main chain of the aromatic polymer compound comprises at least one recurring structure represented by any one of the following formulae (3-1)-(3-5): 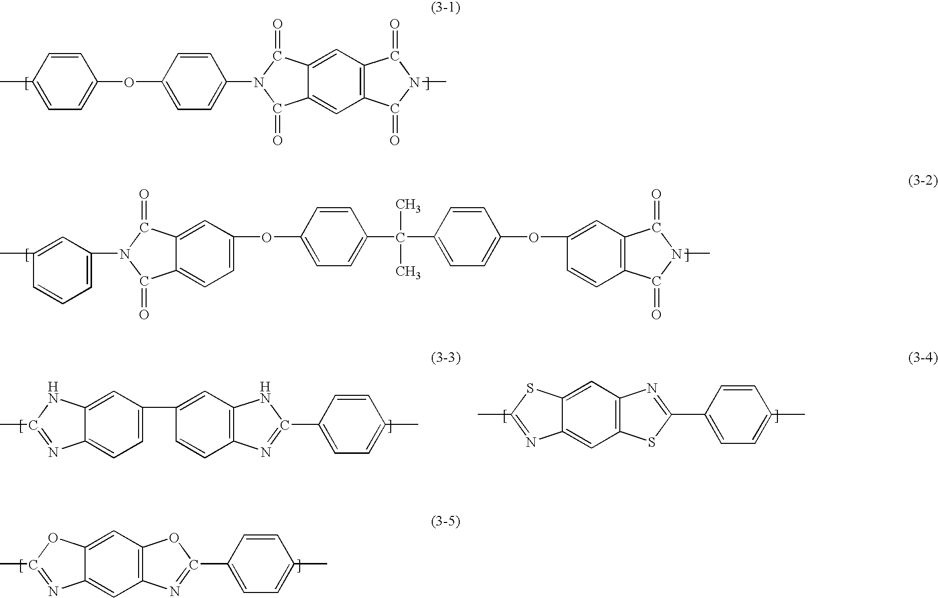
(18) The solid electrolyte according to any of (13)-(17), wherein the aromatic polymer compound comprises a side chain represented by the following formula (B): 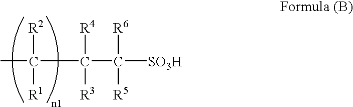
wherein each of R¹-R⁶ independently represents a hydrogen atom or a substituent, provided that at least one of R⁵ and R⁶ represents a substituent. n1 represents 0 or an integer of 1-20.
(19) The solid electrolyte according to any of (13)-(17) which is in the form of film.
(20) A film and electrode assembly comprising the solid electrolyte according to any of (13)-(17).
(21) A film and electrode assembly comprising the solid electrolyte according to any of (13)-(17) on an electrode.
(22) A film and electrode assembly comprising a pair of electrodes and the solid electrolyte according to any of (13)-(17) in the form of film arranged between the electrodes.
(23) A fuel cell including a film and electrode assembly comprising the solid electrolyte according to any of (13)-(17) on the electrode.
(24) A method for producing the solid electrolyte according to any of (13)-(17) comprising introducing a sulfonic acid group through a reaction using a halogenated alkane.

### BRIEF DESCRIPTION OF THE DRAWINGS

FIG. 1 is a schematic cross-sectional view showing constitution of a catalyst electrode assembly film using the solid electrolyte of the invention.

FIG. 2 is a schematic cross-sectional view showing an example of construction of the fuel cell of the invention.

### BEST MODE FOR CARRYING OUT THE INVENTION

Hereinafter, contents of the present invention will be described in detail. In this connection, in the specification of the application concerned, “to” is used in such meaning that numeric values described before and after it are included as the lower limit and the upper limit, respectively. Further, “an A-substituted B group” means a B group substituted by an A. For example, a halogen-substituted alkyl group means an alkyl group substituted by a halogen atom (such as a fluorine atom and a chlorine atom).

Polymer in the present invention is intended to include so-called copolymer formed by polymerizing 2 or more kinds of monomers.

Further, as an a position in the invention, it is intended to designate a carbon atom directly bonded with a sulfonic acid group as an a carbon, and the bonding position thereof as an a position.

1. Solid Electrolyte

The solid electrolyte of the invention is a solid electrolyte including (1) a solid electrolyte including at least an aromatic polymer compound in which an acid residue bonds to an aromatic ring included in a main chain via a carbon-carbon double bond, or (2) an aromatic polymer compound having a main chain including an aromatic ring and a side chain bonding to the aromatic ring, in which a carbon atom at an a position of the side chain is bonded with at least one substituent as well as a sulfonic acid group.

(1) A Solid Electrolyte Including at Least an Aromatic Polymer Compound in Which an Acid Residue Bonds to an Aromatic Ring Included in a Main Chain Via a Carbon-Carbon Double Bond

A first solid electrolyte of the invention is a solid electrolyte including at least an aromatic polymer compound in which an acid residue bonds to an aromatic ring included in a main chain via a carbon-carbon double bond. In preferable cases, the carbon-carbon double bond in the side chain is formed between an a carbon and a β carbon, or the carbon-carbon double bond in the side chain becomes a part of the aromatic ring (preferably a phenyl group). Of course, embodiments other than these are not excluded.

A compound for use as the main chain is not particularly restricted only when it has an aromatic ring. For example, main chains represented by the following (1)-(3) are preferable.

Example of Main Chain (1)

Preferable one includes at least one recurring structure represented by the following formula (1) or (4).
-R¹¹-X- (1)
-R¹⁴ (4)
wherein each of R¹¹ and R¹⁴ independently represents a group consisting of at least one linking group represented by the following formulae (5)-(24): 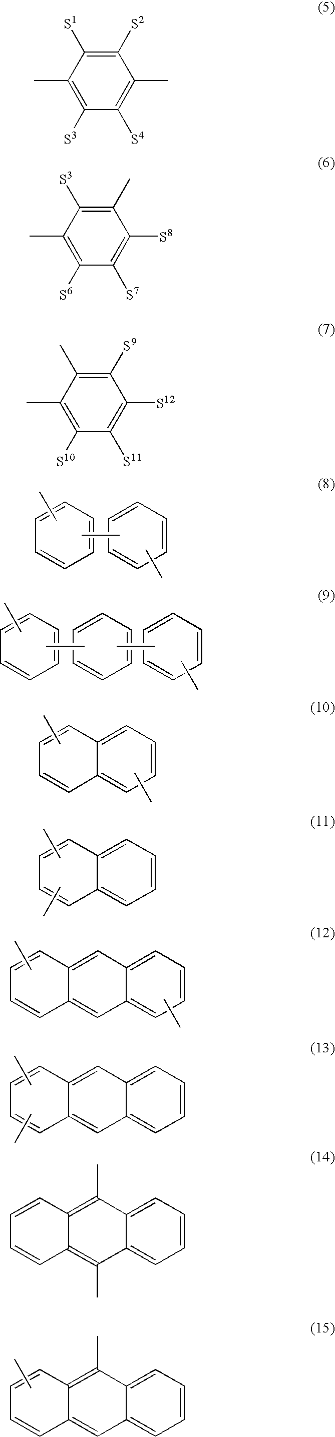 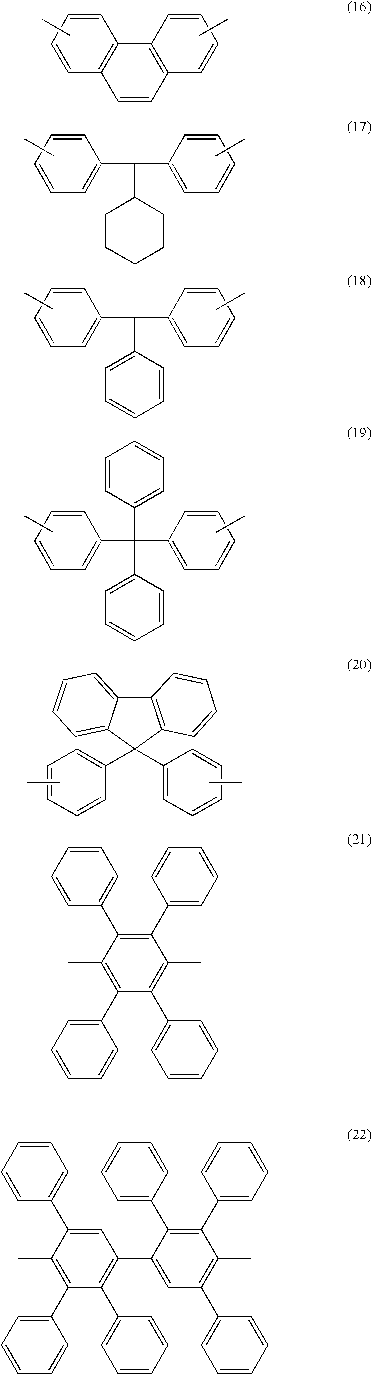 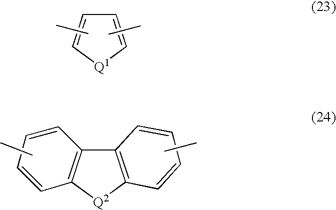
wherein each of S¹-S¹² in (5)-(7) independently represents a hydrogen atom or a substituent, Q¹ in (23) represents —O— or —S—, and Q² in (24) represents —O—, —CH₂—, —CO— or —NH₂—.

X represents —C(R²⁵R²⁶)—, —O—, —S—, —CO—, —SO— or —SO₂—, and each of R²⁵ and R²⁶ independently represents a hydrogen atom, an alkyl group, an alkenyl group, an aryl group or a halogen-substituted alkyl group.

In this connection, each of the recurring structure represented by formula (1) or (4) may be of only 1 kind or 2 kinds or more.

Example of Main Chain (2)

Preferable one has a high heat resistance. Specific preferable examples include a polyethersulfon-based compound, a polyetherethersulfone-based compound, a polyetheretherketone-based compound, a polyphenylenesulfide-based compound, a polyphenyleneether-based compound, a polysulfone-based compound, a polyetherketone-based compound, a polyimide-based compound and a polyetherimide-based compound. 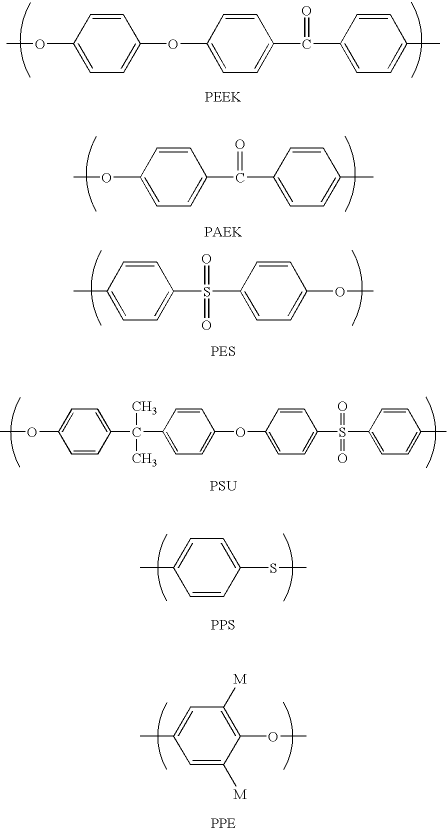
wherein M represents an alkyl group or a phenyl group having 1-10 carbon atoms. 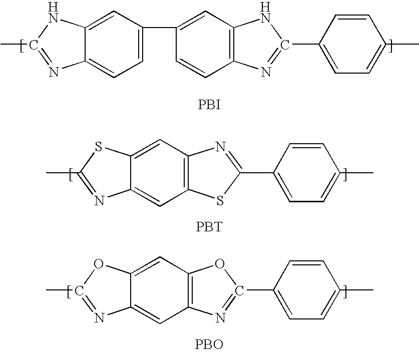
Example of Main Chain (3)

Preferable one includes at least one recurring structure represented by any one of the following formulae (2-1)-(2-4): 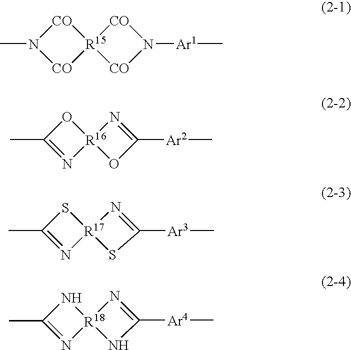
wherein each of R¹⁵-R¹⁸ independently represents a quadrivalent group having 6-36 carbon atoms, and forms a cyclic structure with adjacent 2 bonding groups. Each of Ar¹-Ar⁴ independently represents a divalent group having 6-24 carbon atoms.

In the formulae (2-1)-(2-4), R¹⁵-R¹⁹ have, preferably, an aromatic ring, more preferably a benzene ring. Here, “each of them forms a cyclic structure with adjacent 2 bonding groups” means that 4 bonding groups of R¹⁵-R¹⁸ (or 4 bonding groups and other atoms) bond with adjacent atoms on right and left sides to form rings. Preferably a formed cyclic structure is a 5-membered ring or a 6-membered ring. Further, each of R¹⁵-R¹⁸ is not necessarily formed only by a cyclic structure formed by bonding with adjacent atoms as an indispensable requirement, but may be a group consisting of a combination of a cyclic structure and another group. As the aforementioned other group, one including a cyclic structure is preferable, and one including an aromatic ring is preferable. Further, a ring included as the other group may be ring-condensed with a cyclic structure formed with the aforementioned respective 2 bonding groups.

In the formulae (2-1)-(2-4), each of Ar¹-Ar⁴ is preferably a group having an aromatic ring, more preferably a group having a benzene ring.

Examples of compounds represented by formulae (2-1)-(2-4) are shown below, however, the invention is not restricted to these.

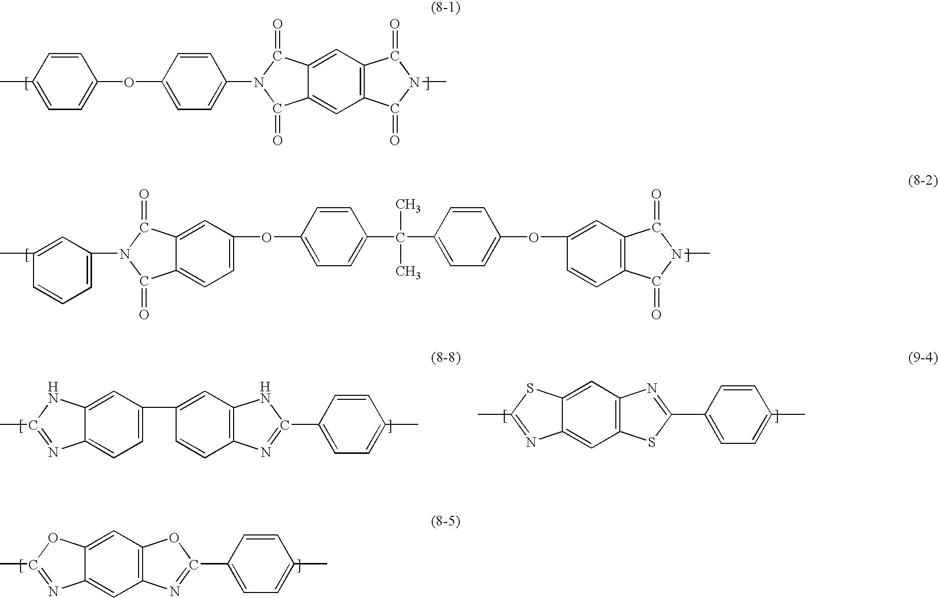

The preferable side chain is a group having a group represented by the following formula (A): 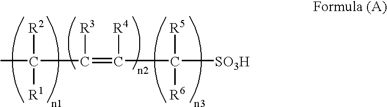
wherein each of R¹-R⁶ independently represents a hydrogen atom or a substituent, and two or more of R¹-R⁶ may bond to each other to form a ring. n1 represents 0 or an integer of 1-20, n2 represents an integer of 1-3, and n3 represents 0 or an integer of 1-10.

Preferable respective substituents of R¹-R⁶ in formula (A) are any of the following group of substituent groups T. Group of substituent groups T

1. Alkyl Group

An alkyl group may have a substituent. It is an alkyl group having more preferably 1-24 carbon atoms, further preferably 1-10 carbon atoms, and may be of a strait chain or a branched chain. Examples include a methyl group, an ethyl group, a propyl group, a butyl group, an isopropyl group, an isobutyl group, a pentyl group, a hexyl group, an octyl group, a 2-ethylhexyl group, a tert-octyl group, a decyl group, a dodecyl group, a tetradecyl group, a 2-hexyldecyl group, a hexadecyl group, an octadecyl group, a cyclohexylmethyl group, an octylcyclohexyl group and the like.

2. Aryl Group

An aryl group may include a substituent or be a condensed ring. More preferably it is an aryl group having 6-24 carbon atoms, including, for example, a phenyl group, a 4-methylphenyl group, a 3-cyanophenyl group, a 2-chlorophenyl group, a 2-naphthyl group and the like.

3. Heterocyclic Group

A heterocyclic group may have a substituent or be a condensed ring. When it is a nitrogen-containing heterocyclic group, a nitrogen in the ring may be quaternized. More preferably, it is a heterocyclic group having 2-24 carbon atoms, including, for example, a 4-pyridyl group, a 2-pyridyl group, a 1-octylpyridinium-4-yl group, a 2-pyrimidyl group, a 2-imidazolyl group, a 2-thiazolyl group and the like.

4. Alkoxy Group

An alkoxy group having 1-24 carbon atoms is more preferable, including, for example, a methoxy group, an ethoxy group, a butoxy group, an octyloxy group, a methoxyethoxy group, a methoxypenta(ethyloxy) group, an acryloyloxyethoxy group, a pentafluoropropoxy group and the like.

5. Acyloxy Group

An acyloxy group having 1-24 carbon atoms is more preferable, including, for example, an acetyloxy group, a benzoyloxy group and the like.

6. Alkoxycarbonyl Group

An alkoxycarbonyl group having 2-24 carbon atoms is more preferable, including, for example, a methoxycarbonyl group, an ethoxycarbonyl group and the like.

7. Cyano Group

8. Acid Residue

A sulfonic acid group, a carbonyl group and a phosphonic acid group are more preferable.

9. Alkoxycarbonyl Group

10. Alkenyl Group

An alkenyl group having 2-24 carbon atoms are more preferable.

11 Halogen Atom

A fluorine atom and a chlorine atom are more preferable.

12. Hydroxyl Group

As a substituent of R¹-R⁶, there can be mentioned more preferably an alkyl group (such as a methyl group and an ethyl group), an alkenyl group, an aryl group (such as a phenyl group), a halogen atom, a hydroxyl group, a sulfonic acid group, a carbonyl group or a phosphonic acid group, further preferably a methyl group, a hydroxyl group, a sulfonic acid group, a carbonyl group or a phosphonic acid group.

The case where 2 or more of R¹-R⁶ bond to each other to form a ring means that any 2 or more groups of R¹-R⁶ form a ring by making a bond or bonds, including a case where 3 or more of them, such as R², R³ and R⁴; R¹, R³ and R⁴; R³, R⁴ and R⁵; or R³, R⁴ and R⁶, make bonds to form a ring, in addition to a case where adjacent groups make a bond. Further, also R¹ and R¹ or the like may make a bond to form a ring. When a ring is to be formed, any of R¹ and R², R³ and R⁴, and R⁵ and R⁶ preferably forms a ring, and more preferably at least R³ and R⁴ form a ring. Of course, the preferable embodiment of the invention includes a case where no ring has been formed.

A cyclic group formed by bonding of R¹-R⁶ is preferably a group composed of a substituted or unsubstituted cyclic hydrocarbon or a heterocycle.

The cyclic hydrocarbon or the heterocycle may be monocyclic or polycyclic, and is more preferably a 5-membered ring, a 6-membered ring, or a ring formed by condensation of 2 or more of these rings. In the case where rings are condensed, for example, each of rings formed by bonding of R¹ and R², R³ and R⁴, or R⁵ and R⁶ may be condensed. In addition, as the cyclic hydrocarbon or a heterocycle, a ring having an aromatic property is preferable. Number of carbons of the cyclic hydrocarbon or the heterocycle is preferably 5-18, more preferably 5-12. The heterocycle preferably contains a nitrogen atom, a oxygen atom, or a sulfur atom as a hetero atom.

More specifically, a cyclic group formed by bonding of R¹-R⁶ is preferably a benzene ring or a naphthalene ring.

Further, these rings having a substituent is also preferable as the cyclic hydrocarbon or a heterocycle of the invention. As the substituent in this case, the above-described group of substituents T can be mentioned.

n1 is preferably 0-10, more preferably 0-2. When n1 is 2 or more, each of plural R¹s and R²s may be identical to or different from each other.

n2 is preferably 1. When n2 is 2 or more, each of plural R³s and R⁴S may be identical to or different from each other.

n3 is preferably 0-3, more preferably 0-2. When n3 is 2 or more, each of plural R⁵s and R⁶s may be identical to or different from each other.

Among the aforementioned formula (A), following (A-1) or (A-2) are more preferable.

(A-1)

Each of R¹-R⁶ independently represents a hydrogen atom or a substituent, n1 is 1- or 2 (preferably 1), n2 is an integer of 1-3 (preferably 1), and n3 is 0.

The substituent in this case includes the same groups as described for the substituent of R¹-R⁶ of the formula (A), and is preferably an alkyl group (more preferably a methyl group).

In the more preferable case, none of R¹-R⁶ forms a ring.

(A-2)

Each of R¹, R², R⁵ and R⁶ independently represents a hydrogen atom or a substituent, wherein at least R³ and R⁴ form a ring by mutual bonding of respective substituents, n1 is 0 or 1, n2 is 1, and n3 is 1 or 2 (preferably 1).

The substituent in this case includes the same groups as described for the substituent of R¹-R⁶ of the formula (A), and is preferably an alkyl group or a halogen atom, more preferably a halogenated alkyl group or a halogen atom, further preferably a fluorinated alkyl group or a fluorine atom.

A ring formed by mutual bonding of R³ and R⁴ has the same meaning and preferable range as described in the description of the formula (A).

In addition, the preferable group represented by the formula (A) also includes groups represented by the following formula (1-1) or (1-2): 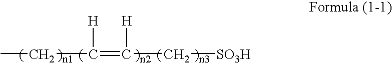
wherein n1 represents 0 or an integer of 1-20 (preferably 1-10) n2 represents an integer of 1-3 (preferably 1 or 2), and n3 represents 0 or an integer of 1-10 (preferably 0); 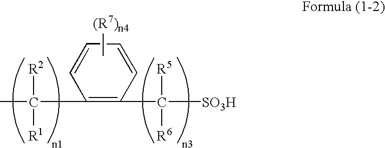
wherein each of R¹, R², R⁵ and R⁶ independently represents a hydrogen atom or a substituent (preferably either R⁵ or R⁶ is not a hydrogen atom), R⁷ represents a hydrogen atom or a substituent (preferably a hydrogen atom), n1 represents 0 or an integer of 1-20 (preferably 0-10), n3 represents 0 or an integer of 1-10 (preferably 0-4), and n4 represents 0 or an integer of 1-4 (preferably 0).

As the side chain, the group represented by the formula (A) may bond to the main chain directly or via a divalent linking group. Examples of the divalent linking group include, preferably, a group composed of at least 1 kind of an alkylene group, an arylene group and a hetero atom, more preferably a group composed of a combination of an alkylene or arylene group and a hetero atom, an alkylene group or a hetero atom, further preferably a group composed of a combination of a hetero atom and an alkylene group. Preferably, the alkylene group has 1-10 carbon atoms, the arylene group has 6-12 carbon atoms, and the hetero atom is an oxygen, sulfur or nitrogen atom.

Molecular weight of the aforementioned solid electrolyte may by arbitrary depending on synthesis conditions, but number average molecular weight is preferably 3,000-500,000, more preferably 20,000-200,000.

Tg (glass transition temperature) thereof is preferably 100° C. or more, more preferably 120° C. or more, further preferably 150° C. or more.

Ratio of the sulfonic acid group of the polymer aromatic compound is preferably 200-5000 (g/equivalent weight), more preferably 300-2000 (g/equivalent weight), further preferably 300-1000 (g/equivalent weight).

For the solid electrolyte of the invention, examples of the relation between the main chain and the side chain include the following. Of course, other combinations are not excluded. Here, the relation is represented by the form of the main chain: the side chain. PEEK: formula (1); PEAK: formula (1); PEK: formula (1); PK: formula (1); PPS: formula (1); PES: formula (1); PEEK: formula (1-1); PEAK: formula (1-1); PEK: formula (1-1); PK: formula (1-1); PPS: formula (1-1); PES: formula (1-1); PEEK: formula (1-2); PEAK: formula (1-2); PEK: formula (1-2); PK: formula (1-2); PPS: formula (1-2); PES: formula (1-2); PEEK: formula (1) satisfying the aforementioned (A); PEAK: formula (1) satisfying the (A); PEK: formula (1) satisfying the (A); PK: formula (1) satisfying the (A); PPS: formula (1) satisfying the (A); PES: formula (1) satisfying the (A); PEEK: formula (1) satisfying the aforementioned (B); PEAK: formula (1) satisfying the (B); PEK: formula (1) satisfying the (B); PK: formula (1) satisfying the (B); PPS: formula (1) satisfying the (B); PES: formula (1) satisfying the (B);

PEEK: a divalent linking group-formula (1); PEAK: a divalent linking group-formula (1); PEK: a divalent linking group-formula (1); PK: a divalent linking group-formula (1); PPS: a divalent linking group-formula (1); PES: a divalent linking group-formula (1); PEEK: a divalent linking group-formula (1-1); PEAK: a divalent linking group-formula (1-1); PEK: a divalent linking group-formula (1-1); PK: a divalent linking group-formula (1-1); PPS: a divalent linking group-formula (1-1); PES: a divalent linking group-formula (1-1); PEEK: a divalent linking group-formula (1-2); PEAK: a divalent linking group-formula (1-2); PEK: a divalent linking group-formula (1-2); PK: a divalent linking group-formula (1-2); PPS: a divalent linking group-formula (1-2); PES: a divalent linking group-formula (1-2); PEEK: a divalent linking group-formula (1) satisfying the aforementioned (A); PEAK: a divalent linking group-formula (1) satisfying the (A); PEK: a divalent linking group-formula (1) satisfying the (A); PK: a divalent linking group-formula (1) satisfying the (A); PPS: a divalent linking group-formula (1) satisfying the (A); PES: a divalent linking group-formula (1) satisfying the (A); PEEK: a divalent linking group-formula (1) satisfying the aforementioned (B); PEAK: a divalent linking group-formula (1) satisfying the (B); PEK: a divalent linking group-formula (1) satisfying the (B); PK: a divalent linking group-formula (1) satisfying the (B); PPS: a divalent linking group-formula (1) satisfying the (B); PES: a divalent linking group-formula (1) satisfying the (B)

(2) A Solid Electrolyte Including an Aromatic Polymer Compound Having a Main Chain Having an Aromatic Ring and a Side Chain Bonding to the Aromatic Ring, in Which a Carbon Atom at an a Position of the Side Chain is Bonded with at Least One Substituent as Well as a Sulfonic Acid Group

A second solid electrolyte of the invention is a solid electrolyte including an aromatic polymer compound having a main chain including an aromatic ring and a side chain bonding to the aromatic ring, in which a carbon atom at an a position of the side chain is bonded with at least one substituent as well as a sulfonic acid group.

As the compound used as the main chain, one similar to the main chain of the aromatic polymer compound described for the first solid electrolyte can be used, which also has a similar preferable range.

The side chain is not particularly restricted only when it is a group having a sulfonic acid group and a substituent bonding at α position, but a preferable side chain has a group represented by the following formula (B): 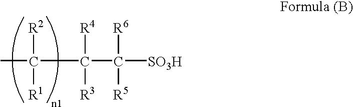
wherein each of R¹-R⁶ independently represents a hydrogen atom or a substituent, provided that at least one of R⁵ and R⁶ represents a substituent. n1 represents 0 or an integer of 1-20.

Here, when each of R¹-R⁶ is a substituent, it is preferably any group included in the aforementioned group of substituents T, more preferably an alkyl group, an alkenyl group, an aryl group, a halogen atom, a hydroxyl group, a sulfonic acid group, a carbonyl group or a phosphonic acid group, further preferably an alkyl group having 1-20 carbon atoms, a fluorine atom, a hydroxyl group, a sulfonic acid group, a carbonyl group or a phosphonic acid group.

Preferably one of R⁵ and R⁶ is a substituent and the other is a hydrogen atom.

Preferably each of R¹-R⁴ is a hydrogen atom.

n1 represents 0 or an integer of 1-20, wherein 0 and an integer of 1-10 are more preferable. When n1 is 2 or more, each of R¹s and R²s is identical to or different from each other.

The side chain may bond via a group composed of at least one of an alkyl group, an aryl group and a hetero atom (in the alkyl group or the aryl group, a part of carbon atoms may have been replaced by a hetero atom). Among them, a side chain preferably bonds via an alkyl group, an aryl group or a hetero atom (in the alkyl group or the aryl group, a part of carbon atoms may have been replaced by a hetero atom), a side chain more preferably bonds via an alkyl group (in the alkyl group, a part of carbon atoms may have been substituted by a hetero atom) or a hetero atom, wherein an alkyl group having 1-10 carbon atoms (in the alkyl group, a part of carbon atoms may have been substituted by an oxygen atom, a sulfur atom or a nitrogen atom), an oxygen atom, a sulfur atom or a nitrogen atom is preferable.

In the invention, preferably the group represented by the formula (B) directly bonds to the main chain.

2. Method for Producing a Solid Electrolyte

A method for producing the solid electrolyte of the invention is not particularly restricted, but publicly known methods can be widely employed.

The method for producing the polymer solid electrolyte of the invention will be described below. However, as long as the solid electrolyte of the invention can be synthesized, usable methods include known methods of halomethylation and Williamson ether synthesis.

As an example of method for synthesizing the main chain of the aromatic polymer compound of the invention, there can be mentioned a production method in which a sulfone compound represented by the following formula (26) and an aromatic diol represented by the following formula (27) are subjected to polycondensation: 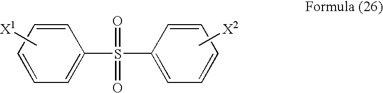
wherein each of X¹ and X² independently represents a halogen atom (preferably a fluorine atom or a chlorine atom) or a nitro group; 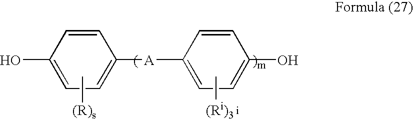
wherein A independently represents a divalent group selected from —C(R⁵¹R⁶¹)—, —O—, —S—, —CO—, —SO— or —SO₂—, R⁵¹ and R⁶¹ independently represents a hydrogen atom, an alkyl group (such as a methyl group, an ethyl group and a benzyl group), an alkenyl group, an aryl group ora halogen-substituted alkyl group (such as a trifluoromethyl group and a pentafluoroethyl group), wherein A preferably represents —C(CH₃)₂—, —C(CF₃)₂—, —O—, —S—, —CO— or —SO₂—. m represents 0, 1 or 2. R and R¹ represent, independently from each other, an alkyl group having 1-10 carbon atoms, and s and sⁱ represent, independently from each other, 0 or an integer of 1-4.

As the sulfonic acid group-including polymer compound represented by formula (26), for example, compounds shown below can be mentioned.

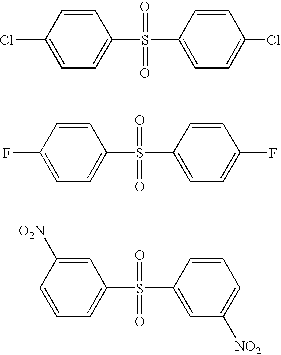

These sulfone compounds can be used independently or in a mixture of 2 kinds or more.

Examples of the compound represented by the formula (27) include hydroquinone, resorcin, 2-methylhydroquinone, 2-ethylhydroquinone, 2-propylhydroquinone, 2-butylhydroquinone, 2-hexylhydroquinone, 2-octylhydroquinone, 2-decanylhydroquinone, 2,3-dimethylhydroquinone, 2,3-diethylhydroquinone, 2,5-dimethylhydroquinone, 2,5-diethylhydroquinone, 2,6-dimethylhydroquinone, 2,3,5-trimethylhydroquinone, 2,3,5,6-tetramethylhydroquinone, 4,4′-dihydroxybiphenyl, 2,2′-dihydroxybiphenyl, 3,3′-dimethyl-4,4′-dihydroxybiphenyl, 3,3′,5,5′-tetramethyl-4,4′-dihydroxybiphenyl, 3,3′-dichloro-4,4′-dihydroxybiphenyl, 3,3′,5,5′-tetrachloro-4,4′-dihydroxybiphenyl, 3,3′-dibromo-4,4′-dihydroxybiphenyl, 3,3′,5,5′-tetrabromo-4,4′-dihydroxybiphenyl, 3,3′-difluoro-4,4′-dihydroxybiphenyl, 3,3′, 5,5′-tetrafluoro-4,4′-dihydroxybiphenyl, 4,4′-dihydroxydiphenylmethane, 2,2-dihydroxydiphenylmethane, 3,3′-dimethyl-4,4′-dihydroxydiphenylmethane, 3,3′,5,5′-tetramethyl-4,4′-dihydroxydiphenylmethane, 3,3′-dichloro-4,4′-dihydroxydiphenylmethane, 3,3′,5,5′-tetrachloro-4,4′-dihydroxydiphenylmethane, 3,3′-dibromo-4,4-dihydroxydiphenylmethane, 3,3′,5,5′-tetrabromo-4,4′-dihydroxydiphenylmethane, 3,3′-difluoro-4,4′-dihydroxydiphenylmethane, 3,3′, 5,5′-tetrafluoro-4,4′-dihydroxydiphenylmethane, 4,4′-dihydroxydiphenylether, 2,2′-dihydroxydiphenylether, 3,3′-dimethyl-4,4′-dihydroxydiphenylether, 3,3′,5,5′-tetramethyl-4,4′-dihydroxydiphenylether, 3,3′-dichloro-4,4′-dihydroxydiphenylether, 3,3′,5,5′-tetrachloro-4,4′-dihydroxydiphenylether, 3,3′-dibromo-4,4′-dihydroxydiphenylether, 3,3′,5,5′-tetrabromo-4,4′-dihydroxydiphenylether, 3,3′-difluoro-4,4′-dihydroxydiphenylether, 3,3′, 5,5′-tetrafluoro-4,4′-dihydroxydiphenylether, 4,4′-dihydroxydiphenylsulfide, 2,2′-dihydroxydiphenylsulfide, 3,3′-dimethyl-4,4′-dihydroxydiphenylsulfide, 3,3′,5,5′-tetramethyl-4,4′-dihydroxydiphenylsulfide, 3,3′-dichloro-4,4′-dihydroxydiphenylsulfide, 3,3′,5,5′-tetrachloro-4,4′-dihydroxydiphenylsulfide, 3,3′-dibromo-4,4′-dihydroxydiphenylsulfide, 3,3′,5,5′-tetrabromo-4,4′-dihydroxydiphenylsulfide, 3,3′-difluoro-4,4′-dihydroxydiphenylsulfide, 3,3′,5,5′-tetrafluoro-4,4′-dihydroxydiphenylsulfide, 4,4′-dihydroxydiphenylsulfone, 2,2′-dihydroxydiphenylsulfone, 3,3′-dimethyl-4,4′-dihydroxydiphenylsulfone, 3,3′,5,5′-tetramethyl-4,4′-dihydroxydiphenylsulfone, 3,3′-dichloro-4,4′-dihydroxydiphenylsulfone, 3,3′,5,5′-tetrachloro-4,4′-dihydroxydiphenylsulfone, 3,3′-dibromo-4,4′-dihydroxydiphenylsulfone, 3,3′,5,5′-tetrabromo-4,4′-dihydroxydiphenylsulfone, 3,3′-difluoro-4,4′-dihydroxydiphenylsulfone, 3,3′,5,5′-tetrafluoro-4,4′-dihydroxydiphenylsulfone, 2,2-bis(4-hydroxyphenyl)propane, 2,2-bis(2-hydroxyphenyl)propane, 2,2-bis(3-methyl-4-hydroxyphenyl)propane, 2,2-bis(3-chloro-4-hydroxyphenyl)propane, 2,2-bis(3,5-dichloro-4-hydroxyphenyl)propane, 2,2-bis(3-bromo-4-hydroxyphenyl)propane, 2,2-bis(3,5-dibromo-4-hydroxyphenyl)propane, 2,2-bis(3-fluoro-4-hydroxyphenyl)propane, 2,2-bis(3,5-difluoro-4-hydroxyphenyl)propane, 2,2-bis(3,5-dimethyl-4-hydroxyphenyl)propane, α,α′-bis(4-hydroxyphenyl)-1,4-diisopropylbenzene, α,α′-bis(2-hydroxyphenyl)-1,4-diisopropylbenzene, α,α′-bis(4-hydroxyphenyl)-1,3-diisopropylbenzene, α,α′-bis(2-hydroxyphenyl)-1,3-diisopropylbenzene, α,α′-bis(3-methyl-4-hydroxyphenyl)-1,4-diisopropylbenzene, α,α′-bis(3,5-dimethyl-4-hydroxyphenyl)-1,4-diisopropylbenzene, α,α′-bis(3-methyl-4-hydroxyphenyl)-1,3-diisopropylbenzene, and α,α′-bis(3,5-dimethyl-4-hydroxyphenyl)-1,3-diisopropylbenzene.

The ratio (mole ratio) of the compound represented by the formula (26) and the compound represented by the formula (27) is preferably from 0.9-1.1 moles, more preferably 0.93-1.07 moles, further preferably 0.95-1.05 moles of the compound represented by the formula (26) relative to 1 mole of the compound represented by the formula (27).

The reaction employed in the invention for producing a sulfonic acid group-including aromatic polymer compound is usually carried out in a solvent.

Preferable examples of the solvent include the following.

1) Ether-Based Solvent

1,2,-dimethoxyethane, bis(2-methoxyethyl)ether, 1,2-bis(2-methoxyethoxy)ethane, tetrahydrofuran, bis [2-(2-methoxyethoxy)ethyl]ether, 1,4-dioxane, and the like are included.

The concentration of the reaction carried out in the solvent (hereinafter, referred to as polymerization concentration) can be adjusted without particular restriction as long as it does not deviate from the purport of the invention.

When the solvents of 1)-5) are used in a mixture, there is no necessity to select a combination of the solvents which dissolve mutually in an arbitrary ratio. A mixture in which solvents are not mixed to each other to be heterogeneous may be usable. There is no restriction on a use amount of the dehydration agent.

There are no particular restriction on reaction temperature, reaction time and reaction pressure, and publicly known conditions can be applied. For example, the reaction temperature is preferably 0-300° C., more preferably 100-270° C., further preferably 130-250° C. The reaction time can be arbitrarily determined according to the kind of a monomer and kind of a solvent to be used and the reaction temperature, and is preferably 1-72 hours, more preferably 3-48 hours, further preferably 5-24 hours. As for the reaction pressure, ordinary pressure is sufficient, although increased or decreased pressure is also acceptable.

In order to introduce a sulfonic acid group to the main chain of the aromatic polymer compound, following introduction methods can be employed.

(1) A Solid Electrolyte Including an Aromatic Polymer Compound in Which an Acid Residue Bonds at Least to an Aromatic Ring Included in the Main Chain Via a Carbon-Carbon Double Bond

Introduction of a side chain including a double bond and a sulfonic acid group to an aromatic polymer compound can be carried out according to a synthesis method described in a known document, for example. As a general method, there is the Friedel-Crafts reaction using sultone shown below and a Lewis acid such as AlCl₃ (Journal of Applied Polymer Science, Vol. 36, 1753-1767, 1988). 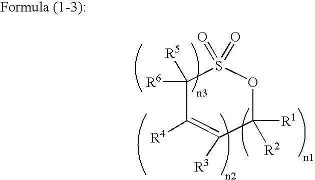
wherein each of R¹-R⁶-independently represents a hydrogen atom or a substituent, wherein 2 or more of R¹-R⁶ may bond to each other to form a ring. n1 represents 0 or an integer of 1-20, n2 represents an integer of 1-3, and n3 represents 0 or an integer of 1-10. Respective R¹-R⁶ and n1-n3 in the formula (1-3) have the same meanings and preferable ranges as R¹-R⁶ and n1-n3 in the aforementioned formula (A). Further, compounds represented by the following formula (1-4) or (1-5) are more preferable: 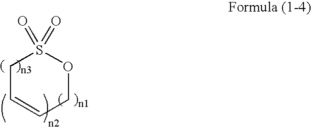
wherein n1 represents 0 or an integer of 1-20 (preferably 1-10), n2 represents an integer of 1-3 (preferably 1 or 2), and n3 represents 0 or an integer of 1-10 (preferably 0); 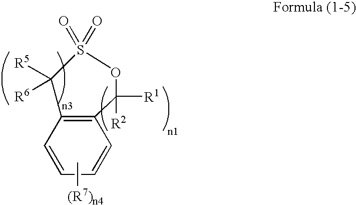
wherein each of R¹, R², R⁵ and R⁶ independently represents a hydrogen atom or a substituent (preferably, one of R⁵ and R⁶ is not a hydrogen atom), R⁷ represents a hydrogen atom or a substituent (preferably a hydrogen atom), n1 represents 0 or an integer of 1-20 (preferably 0 or an integer of 1-10), n3 represents 0 or an integer of 1-10 (preferably 0 or 1-4), and n4 represents 0 or an integer of 1-4 (preferably 0).

Hereinafter, an example of synthesis route of a Friedel-Crafts reaction using a compound represented by formula (1-3) below and AlCl₃ will be shown. Further, a compound including PEEK, PAEK, PES, PPS or PEE exemplified above as a main chain can be treated in the same way. R in the following synthesis route represents the formula (1).

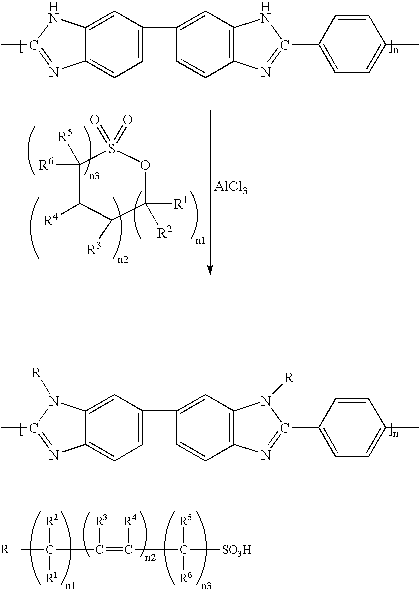

Examples of the compound represented by the formula (1-3) are shown below, however the invention is not restricted to these compounds.

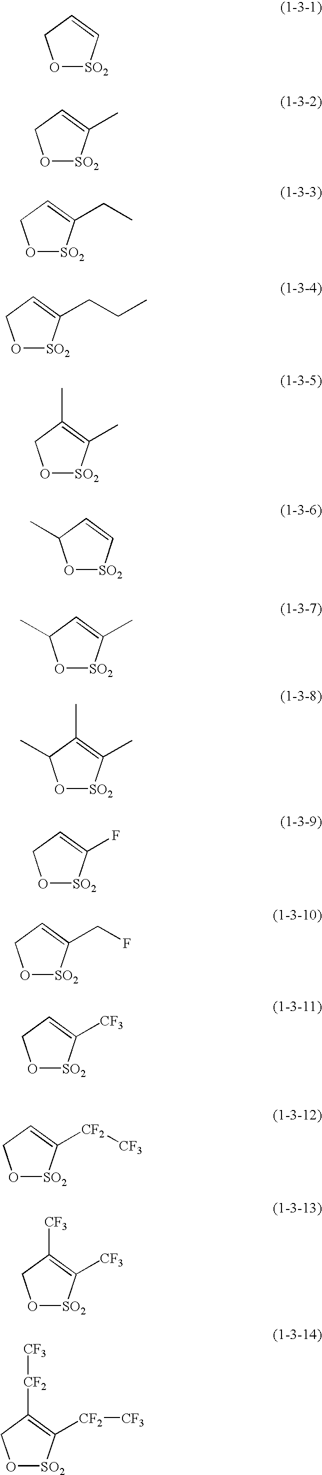

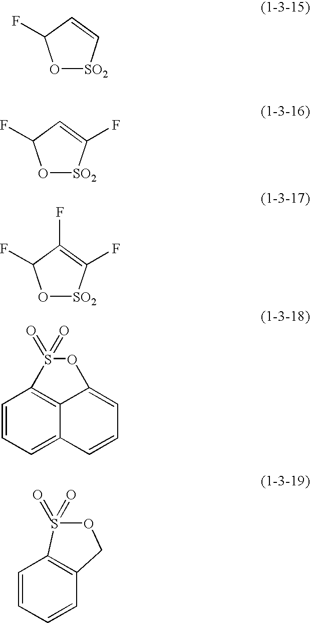

In addition, compounds represented by the following formula (5-1) can be also used for the reaction: 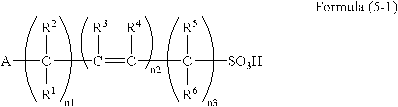
wherein each of R¹-R⁶ independently represents a hydrogen atom or a substituent, and 2 or more of R¹-R⁶ may bond to each other to form a ring. n1 represents 0 or an integer of 1-20, n2 represents an integer of 1-3, and n3 represents 0 or an integer of 1-10. A represents a halogen atom.

Further, respective R¹-R⁶ and n1-n3 in the formula (5-1) have the same meanings and preferable ranges as R¹-R⁶ and n1-n3 in the aforementioned formula (A). A is preferably Cl, Br or F, more preferably Br.

A synthesis route using a compound represented by the following formula (5-1) is exemplified below.

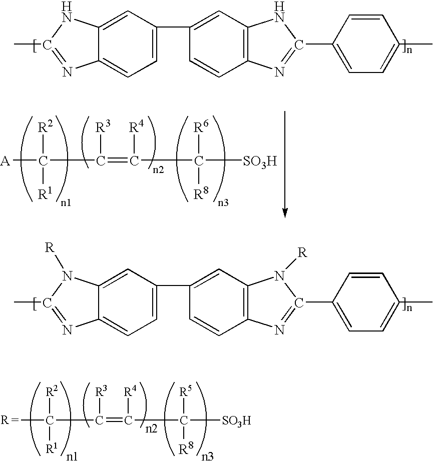

Examples of the compound represented by the formula (5-1) are shown below, but the invention is not restricted to these compounds.

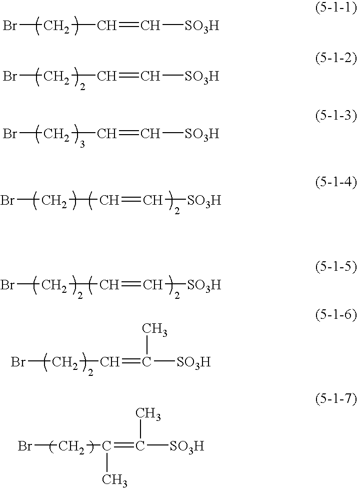

When practicing the Friedel-Crafts reaction, α,β-unsaturated sultone or the like may be used as an alkylsulfonating agent. Examples of usable solvents include hydrocarbons (such as benzene, toluene, nitrobenzene and acetophenone) and halogenated alkanes (such as methylene chloride, chloroform, dichloroethane, carbon tetrachloride, trichloroethane, dichloroethane, tetrachloroethane, chlorobenzene and trichlorobenzene). The reaction temperature may be selected from a range of room temperature (for example, 18° C.) to 250° C. In these reactions, a mixture of 2 or more kinds of solvents may be used.

(2) A Solid Electrolyte Including an Aromatic Polymer Compound Having a Main Chain Including an Aromatic Ring and a Side Chain Bonding to the Aromatic Ring, in which a Carbon Atom at an a Position of the Side Chain is Bonded with at Least One Substituent as Well as a Sulfonic Acid Group

For example, a method can be mentioned in which a halogenomethylating agent such as chloromethylmethyl ether is used to form halogenomethylated polysulfone, with which a compound including a hydroxyl group in the structure and having a sodium sulfonate moiety such as one shown below is reacted by the Williamson ether synthesis.

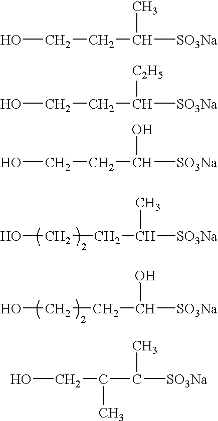

Further, after introducing a hydroxyl group by hydrolysis of halogenomethylated polysulfone using NaOH or CaCO₃, it may be also reacted with a compound in the following group in which a hydroxyl group in the above compounds has been converted to a halogen or sulfonate.

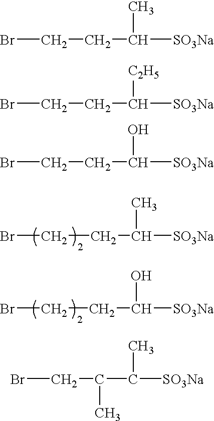

In the invention, examples of the halogenoalkyl group include halogenated alkyl groups (preferably having 1-6 carbon atoms) such as a chloromethyl group, a bromomethyl group, an iodomethyl group, a chloroethyl group, a bromoethyl group, an iodoethyl group, a chloropropyl group, a bromopropyl group, an iodopropyl group, a chlorobutyl group, a bromobutyl group, an iodobutyl group, a chloropentyl group, a bromopentyl group, an iodopentyl group, a chlorohexyl group, a bromohexyl group and an iodohexyl group. Among them, a halogenated methyl group is preferable.

In order to introduce a halogenated methyl group that is preferable in the invention to an aromatic ring (halogenomethylating reaction of an aromatic ring), publicly known reactions can be used broadly. For example, a chloromethyl group is introduced into an aromatic ring by carrying out a chloromethylating reaction by using chloromethylmethyl ether, 1,4-bis(chloromethoxy)butane, 1-chloromethoxy-4-chlorobutane or the like as a chloromethylating agent, and a Lewis acid such as tin chloride, zinc chloride, aluminum chloride and titanium chloride or hydrofluoric acid as a catalyst. The reaction is preferably carried out in a homogeneous system using such a solvent as dichloroethane, trichloroethane, tetrachloroethane, chlorobenzene, dichlorobenzene or nitrobenzene. Further, paraformaldehyde and hydrogen chloride or bromide may be used to introduce a halogenated methyl group into an aromatic ring.

The amount of the sulfonic acid group in the aforementioned polymer compound obtained in the aforementioned way is preferably 0.05-6, more preferably 0.3-4 relative to one unit of the unit (B) constituting the polymer. The sulfonic acid group of 0.05 or more makes the proton conductivity better, and the group of 6 or less can more effectively inhibit the polymer compound from becoming water-soluble polymer due to a too enhanced hydrophilicity, or from decreasing in durability.

In addition, a sulfonic acid group may be introduced by the Friedel-Crafts reaction using sultone shown below and a Lewis acid such as AlCl₃ (Journal of Applied Polymer Science, Vol 36, 1753-1767, 1988): 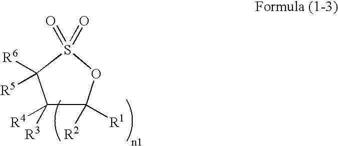
wherein each of R¹-R⁶ independently represents a hydrogen atom or a substituent (at least one of R⁵ and R⁶ is a substituent) n1 represents 0 or an integer of 1-20.

In the formula (1-3), R¹-R⁶ and n1 have the same meanings and preferable ranges as those in the formula (A).

Examples of the compound represented by the formula (1-3) are shown below, but the invention is not restricted to these.

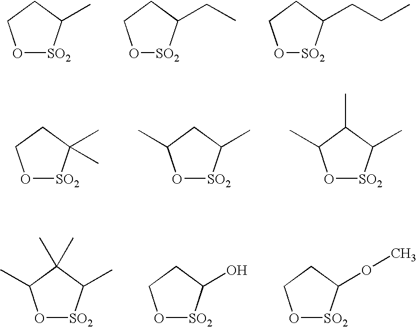

An example of a synthesis route of the Friedel-Crafts reaction using a compound represented by the formula (1-3) and AlCl₃ is shown below. In addition, a compound including PEEK, PAEK, PES, PPS or PEE exemplified above as a main chain can be treated in the same way. R in the synthesis route below represents formula (A).

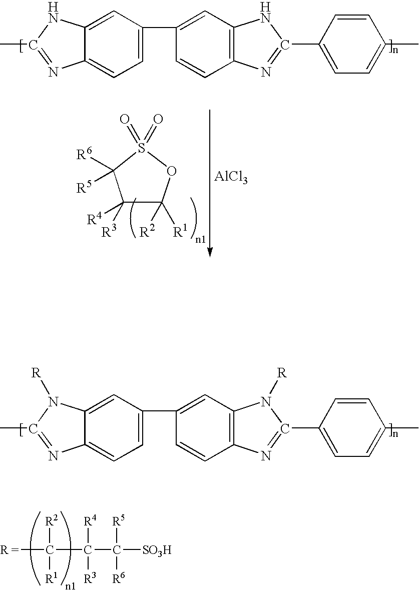

Further, the reaction can be practiced using a compound represented by formula (5-1) below: 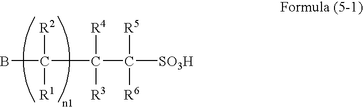
wherein each of R¹-R⁶ independently represents a hydrogen atom or a substituent (at least one of R⁵ and R⁶ is a substituent). B represents a halogen atom. n1 represents 0 or an integer of 1-20.

Further, R¹-R⁶ and n1 in the formula (5-1) have the same meanings and preferable ranges as those in R¹-R⁶ and n1 of the formula (A). B is preferably Cl, Br or F, more preferably Br.

Examples of the compound represented by the formula (5-1) are shown below, however the invention is not restricted to these compounds.

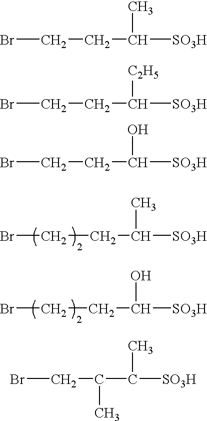

An example of a synthesis route using a compound represented by the formula (5-1) is shown below.

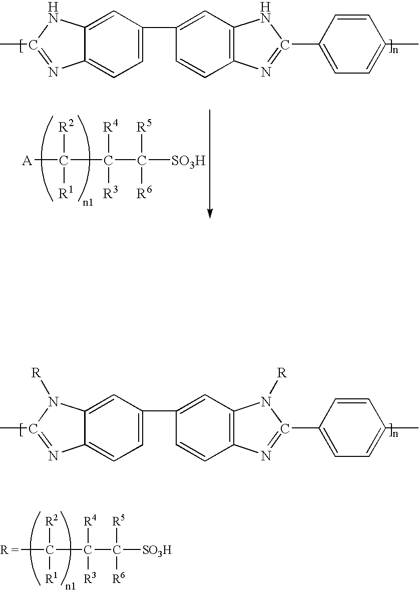

When practicing the Friedel-Crafts reaction, sultone having a substituent at the a position or the like may be used as an alkylsulfonating agent. Examples of usable solvents include hydrocarbons (such as benzene, toluene, nitrobenzene and acetophenone) and halogenated alkanes (such as methylene chloride, chloroform, dichloroethane, carbon tetrachloride, trichloroethane, dichloroethane, tetrachloroethane, chlorobenzene and trichlorobenzene). The reaction temperature may be selected from a range of room temperature (for example, 18° C.) to 250° C. In these reactions, a mixture of 2 or more kinds of solvents may be used.

The molecular weight of polymer precursor before sulfonation of the polymer compound of the invention thus obtained is preferably 1,000-1,000,000, more preferably 1,500-200,000 in weight-average molecular weight in terms of polystyrene. The molecular weight of 1,000 or more can hardly allow a molded film to generate a crack, can improve coating properties and also enhance strength properties. On the other hand, that of 1,000,000 or less leads to a preferable solubility and can more effectively inhibit such problems that the solution viscosity is high and processability is not good.

3. Other Additives of the Solid Electrolyte

The solid electrolyte of the invention contains the aforementioned aromatic polymer compound, and in addition, may contain an inorganic acid such as sulfuric acid and phosphoric acid, an organic acid including carboxylic acid, and a suitable quantity of water. Further, in the invention, a copolymer of a monomer including a group having a sulfonic acid group and a monomer having no sulfonic acid group and the like can be also used preferably.

The solid electrolyte of the invention may be added, according to need, with an oxidation inhibitor, fiber, fine particles, a water-absorbing agent, a plasticizer, a compatibilizing agent and the like in order to enhance film properties when it is used as a solid electrolyte film. The content of these additives is preferably in a range of 1-30% by mass relative to the total amount.

Preferable examples of the oxidation inhibitor include (hindered)phenol-based, mono- or di-valent sulfur-based, tri- to penta-phosphorous-based, benzophenone-based, benzotriazole-based, hindered amine-based, cyanoacrylate-based, salicylate-based, and oxalic acid anilide-based compounds. Specifically, compounds described in JP-A-8-53614, JP-A-10-101873, JP-A-11-114430 and JP-A-2003-151346 can be mentioned. Preferable examples of the fiber include perfluorocabon fiber, cellulose fiber, glass fiber, polyethylene fiber and the like, including, specifically, fibers described in JP-A-10-312815, JP-A-2000-231928, JP-A-2001-307545, JP-A-2003-317748, JP-A-2004-63430 and JP-A-2004-107461.

Preferable examples of the fine particle include-fine particles of silica, alumina, titanium oxide, zirconium oxide and the like. There are descriptions, for example, in JP-A-6-111834, JP-A-2003-17.8777, and JP-A-2004-217921 about these fine particles.

Preferable examples of the water-absorbing agent (hydrophilic material) include cross-linked polyacrylates, starch-acrylates, poval, polyacrylonitrile, carboxymethyl cellulose, polyvinylpyrrolidone, polyglycol dialkylether, polyglycol dialkylester, silica gel, synthesized zeolite, alumina gel, titania gel, zirconia gel, and yttria gel. There are descriptions, for example, in JP-A-7-135003, JP-A-8-20716 and JP-A-9-251857.

Preferable examples of the plasticizer include phosphoric acid ester-based compounds, phthalic acid ester-based compounds, aliphatic monobasic acid ester-based compounds, aliphatic dibasic acid ester-based compounds, dihydric alcohol ester-based compounds, oxyacid ester-based compounds, chlorinated paraffins, alkylnaphthalene-based compounds, sulfone alkylamide-based compounds, oligo ethers, cabonates, and aromatic nitriles. There are descriptions, for example, in JP-A-2003-197030, JP-A-2003-288916, and JP-A-2003-317539.

Further, the solid electrolyte of the invention may be incorporated with various polymer compounds for the purpose of (1) enhancing mechanical strength of the film, or (2) enhancing acid concentration in the film.

(1) For the purpose of enhancing mechanical strength, such polymer compound is suitable that has molecular weight of preferably 10,000-1,000,000 and good compatibility with the solid electrolyte of the invention. For example, perfluorinated polymer, polystyrene, polyethylene glycol, polyoxetane, poly(meth)acrylate, polyether ketone, polyether sulfone and polymers of 2 or more thereof are preferable, and preferable content is in a range of 1-30% by mass relative to the whole.

A preferable compatibilizing agent has a boiling point or a sublimation point of preferably 250° C. or more, more preferably 300° C. or more.

(2) For the purpose of enhancing acid concentration, such materials are preferable as perfluorocarbon sulfonic acid polymer as represented by Nafion®, and polymer compounds having a proton acid moiety such as poly(meth)acrylate having a phosphoric acid group in a side chain and sulfonated heat resistant aromatic polymers such as sulfonated polyetherether keton, sulfonated polyether sulfone, sulfonated polysulfone, sulfonated polybenzimidazole, wherein the content thereof is preferably in a range of 1-30% by mass relative to the total amount.

4. Application of the Solid Electrolyte

The obtained solid electrolyte can be used, for example, as a proton conductive material or an electrolyte for an electrode.

When it is used as a proton conductive material, it preferably has a figure of film, the film having a thickness of preferably 10-500 μm, more preferably 25-150 μm. It may be formed into a film shape, or formed in a balk body and then cut and processed into a film shape. In a film-forming process, film-forming may be carried out by extrusion molding, casting or coating of a liquid prepared by holding an aromatic polymer compound as a raw material at a temperature higher than the melting point thereof, or by dissolving the compound using a solvent. These operations can be practiced by using a film-forming machine provided with rolls such as calendar rolls and cast rolls, or a T die, or by press molding using a press machine. Stretching process may be added to control film thickness or improve film properties.

Further, the film may be subjected to surface treatment after the film-forming process. Such surface treatments can be mentioned as surface roughening, surface cutting, removing and coating. Sometimes these treatments can improve adherence of the film with an electrode.

In addition, the solid electrolyte of the invention may be impregnated in fine pores of a porous substrate to form a film. A film may be formed by coating and impregnating an aromatic polymer compound solution on a porous substrate, or by dipping the substrate in the solution to fill fine pores with the solid electrolyte. Preferable examples of a substrate having fine pores include porous polypropylene, porous polytetrafluoroethylene, porous cross-linked heat resistant polyethylene and porous polyimide.

Furthermore, according to need, heat treatment under humidity-controlled atmosphere or irradiation treatment of radiation (such as visible light, ultraviolet ray, γ-ray and electron beam) to achieve property modification. For the purpose of removing unnecessary components, a washing process with water or an organic solvent and a drying process may be added after a cross-linking process.

As the solid electrolyte of the invention, those having following performances are preferable.

As to ion conductivity, for example, at 25° C., 95% relative humidity (% RH), is preferably 0.005 S/cm or more, more preferably 0.01 S/cm or more.

As to strength, for example, tensile strength is preferably 350 kg/cm² or more, more preferably 400 kg/cm² or more, further preferably 450 kg/cm² or more.

As to durability, rate of change of weight and ion-exchange capacity before and after treatment in 30% hydrogen peroxide at a constant temperature is preferably 20% or less, more preferably 10% or less. Further, a volume swelling ratio in an ion-exchanged water at a constant temperature is preferably 10% or less, more preferably 5% or less.

The solid electrolyte of the invention preferably has a stable water absorption coefficient and moisture content. Further, it preferably has substantially negligible solubility to alcohols, water and mixed solvents thereof. In addition, it preferably has substantially negligible weight loss and figure change when dipped in the above-described solvent.

When it is formed in a film shape, it preferably has a higher ion conductivity in the direction from a front face to a rear face compared with those in other directions.

When the solid electrolyte of the invention is formed in a film shape, thickness thereof is preferably 5-300 μm, more preferably 10-300 μm, further preferably 10-200 μm, particularly preferably 10-100 μm. Heat-resistant temperature of the solid electrolyte of the invention is preferably 100° C. or more, more preferably 150° C. or more, further preferably 200° C. or more. The heat-resistant temperature can be defined as a time period when weight loss reaches 5% by heating the film, for example, at a rate of 1° C./min. The weight loss is calculated while excluding evaporation quantity of water and the like.

5. Fuel Cell

The solid electrolyte of the invention can be used for a fuel cell Membrane and Electrode Assembly (hereinafter, referred to as “MEA”) 10 and a fuel cell employing the MEA.

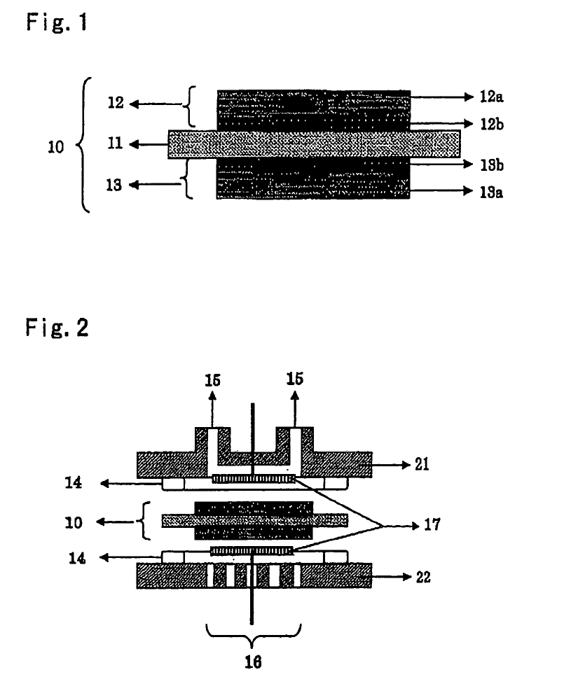

FIG. 1 shows an example of schematic cross-sectional view of the MEA of the invention. MEA 10 is provided with a film-shaped solid electrolyte 11 and an anode electrode 12 and a cathode electrode 13 facing to each other while holding the MEA 10 therebetween.

The anode electrode and the cathode electrode 13 are composed of porous conductive sheets (for example, carbon paper) 12a, 13a, and catalyst layers 12b, 13b. The catalyst layers 12b, 13b are composed of a dispersed substance prepared by dispersing carbon particles (such as Ketchen black, acetylene black and carbon nano tube) carrying a catalyst metal such as platinum powders in a proton conductive material (for example, Nafion® or the like). In order to bring the catalyst layers 12b, 13b into close contact with the solid electrolyte 11, such a method is generally used that the porous conductive sheets 12a, 13a coated with catalyst layers 12b, 13b are pressure-bonded to the solid electrolyte 11 by a hot press method, or the catalyst layers 12b, 13b coated on a suitable support are transferred and pressure-bonded to the solid electrolyte 11, which is then sandwiched between the porous conductive sheets 12a, 13a.

Description will be given about a method for producing an electrode. The solid electrolyte of the invention is dissolved in a solvent, which is mixed with platinum-carrying carbon and dispersed. Preferable examples of the solvent used on this occasion include heterocyclic compounds (such as 3-methyl-2-oxazolidinone and N-methylpyrrolidone), cyclic ethers (such as dioxane and tetrahydrofuran), chain-like ethers (such as diethyl ether, ethylene glycol dialkylether, propyleneglycol dialkylether, polyethyleneglycol dialkylether and polypropyleneglycol dialkylether), alcohols (methanol, ethanol, isopropanol, ethyleneglycol monoalkylether, porpyleneglycol monoalkylether, polyethyleneglycol monoalkylether and polyporpyleneglycol monoalkylether), polyhydric alcohols (such as ethylene glycol, propylene glycol, polyethylene glycol, polypropylene glycol and glycerin), nitrile compounds (acetonitrile, glutarodinitrile, methoxyacetonitrile, propionitrile and benzonitrile), non-polar solvents (such as toluene and xylene), chlorine-containing solvents (such as methylene chloride and ethylene chloride), amides (such as N,N-dimethyl formamide, N,N-dimethyl acetamide, and acetamide) and water. Among these, heterocyclic compounds, alcohols, polyhydric alcohols and amides are preferably used.

A dispersing method may base on stirring, but ultrasonic dispersion, a ball mill or the like may be also used. The resulting dispersion liquid can be coated using the above-mentioned coating method.

Description will be given about coating of a dispersion liquid. In a coating process, the dispersion liquid may be used for film-forming by exclusion molding, or by casting or coating. There is no particular restriction on a support, but preferable examples thereof include a glass substrate, a metal substrate, a polymer film and a reflection plate. Examples of the polymer film include cellulose-based polymer films such as triacetyl cellulose (TAC), ester-based polymer films-such as polyethylene terephthalate (PET) and polyethylene naphthalate (PEN), fluorine-containing polymer films such as polytrifluoroethylene (PTFE), polyimide film and the like. As to a coating system, publicly known methods can be employed, including a curtain coating method, an exclusion coating method, a roll coating method, a spin coating method, a dip coating method, a bar coating method, a spray coating method, a slide coating method and a print coating method. Particularly, when a conductive porous body (carbon paper, carbon cloth) is used as a support, a catalyst electrode can be directly manufactured.

These operations may be also practiced by a film-forming machine using rolls such as calendar rolls or cast rolls, or a T die, or by press molding using a press machine. A stretching process may be added to control film thickness or improve film properties.

Drying temperature in the coating process relates to a drying speed, and can be selected according to properties of the material. It is preferably −20° C.-150° C., more preferably 20° C.-120° C., further preferably 50° C.-100° C. A shorter drying time is more preferable from the viewpoint of productivity, however, in order to suppress generation of cause for such defects as bubbles or irregularity of the surface, a certain period of drying time is desirable. Accordingly, drying time is preferably from 1 minute to 48 hours, more preferably from 5 minutes to 10 hours, particularly preferably from 10 minutes to 5 hours. Control of humidity is also important. 25-100% RH is preferable, and 50-95% RH is more preferable.

The coating liquid in the coating process preferably contains a small amount of metal ions, and particularly preferably contains a small amount of a transition metal ion, especially an iron ion, a nickel ion and a cobalt ion. Specific content is preferably 500 ppm or less, more preferably 100 ppm or less. Accordingly, the solvent used in the aforementioned process preferably contains these ions in a low content.

Further, the film may be subjected to surface treatment after the film-forming process. Such surface treatments can be mentioned as surface roughening, surface cutting, removing and coating. Sometimes these treatments can improve adherence of the film with a solid electrolyte film or a porous conductor.

In order to bring the catalyst layers 12b, 13b into close contact with the solid electrolyte film 11, generally a method is preferably employed in which the porous conductive sheets 12a, 13a coated with catalyst layers 12b, 13b may be press-bonded to the solid electrolyte 11 by a hot press method (preferably at 120-130° C., 2-100 kg/cm²), or suitable supports having been coated with catalyst layers 12b, 13b, respectively, are transferred and pressure-bonded to the solid electrolyte 11, which is then sandwiched between the porous conductive sheets 12a, 13a.

FIG. 2 shows an example of the fuel cell structure. The fuel cell includes the MEA 10 and a pair of separators 21, 22 holding the MEA 10 therebetween, a current collector 17 constituted by a stainless net and attached to the separators 21, 22, and a packing 14. To the anode side separator 21, an anode side opening 15 is arranged, and to the cathode side separator 22, a cathode side opening 16 is arranged. From the anode side opening 15, gas fuel such as hydrogen or alcohols (methanol etc.) or liquid fuel such as an aqueous alcohol solution is supplied, and from the cathode side opening 16, an oxidant gas such as oxygen gas or air is supplied.

Activated polarization in a hydrogen-oxygen system fuel cell is greater for a cathodic pole (air pole) compared with an anodic pole (hydrogen pole). This is because reaction on the cathodic pole (reduction of oxygen) is slower compared with that on the anodic pole. In order to enhance activity of the oxygen pole, various platinum-based bimetals such as Pt—Cr, Pt—Ni, Pt—Co, Pt—Cu, Pt—Fe can be used. In a direct methanol fuel cell which employs an aqueous methanol solution as anode fuel, suppression of catalyst poisoning by CO generating during an oxidation process of methanol is important. For this purpose, platinum-based bimetals such as Pt—Ru, Pt—Fe, Pt—Ni, Pt—Co and Pt—Mo, and trimetals such as Pt—Ru—Mo, Pt—Ru—W, Pt—Ru—Co, Pt—Ru—Fe, Pt—Ru—Ni, Pt—Ru—Cu, Pt—Ru—Sn and Pt—Ru—Au can be used.

As for a carbon material for supporting an active metal, acetylene black, Vulcan XC-72, Ketchen black, carbon nanohorn (CNH) and carbon nanotube (CNT) are preferably used.

The functions of the catalyst layer are: (1) to transport the fuel to the active metal, (2) to provide a field for oxidation reaction (anodic pole) and reduction reaction (cathodic pole) of the fuel, (3) to transmit electrons generated by oxidation-reduction to the current collector, and (4) to transport protons generated by the reaction to the solid electrolyte. In order to accomplish (1), the catalyst layer must be porous to allow the liquid and gas fuels to penetrate deeply. (2) is borne by the aforementioned active metal catalyst, and (3) is borne by the also aforementioned carbon material. In order to fulfill the function of (4), the catalyst layer is mixed with a proton conductive material.

As for the proton conductive material of the catalyst layer, a solid having a proton-donating group can be used without any restriction, but a polymer compound having an acid residue used for the solid electrolyte (for example, perfluorocarbon sulfonic acids as represented by Nafion®, side-chain phosphorous group poly(meth)acrylates, sulfonated compounds of heat-resistant aromatic polymers such as sulfonated polyetheretherketone and sulfonated polybenzimidazole) is used preferably. Use of the solid electrolyte of the invention for a catalyst layer is more advantageous because it becomes the same kind of material as the solid electrolyte to enhance electrochemical adhesion between the solid electrolyte and the catalyst layer.

Suitable use amount of the active metal falls within 0.03-10 mg/cm² from the viewpoint of battery output power and economical efficiency. Suitable amount of the carbon material that carries the active metal is 1-10 times the mass of the active metal. Suitable amount of the proton conductive material is 0.1-0.7 time the mass of the active metal-carrying carbon.

The current collector is also called an electrode base material, a permeable layer or a liner substance, and bears roles of function of current collection and prevention of degradation of gas permeation caused by accumulation of water. Usually, carbon paper or carbon cloth is used, and one having been subjected to polytetrafluoroethylene (PTFE) treatment for the purpose of water repellent finish can also be used.

For manufacturing the MEA, following 4 methods are preferable.

(1) Proton conductive material coating method: wherein a catalyst paste (ink) containing an active metal-carrying carbon, a proton conductive substance and a solvent as fundamental components is directly coated on both sides of the solid electrolyte, to which porous conductive sheets are (thermally) pressure-bonded to manufacture an MEA of 5-layer structure.

(2) Porous conductive sheet coating method: wherein the catalyst paste is coated on the surface of the porous conductive sheet to form a catalyst layer, followed by pressure bonding with the solid electrolyte to manufacture an MEA of 5-layer structure.

(3) Decal method: wherein the catalyst paste is coated on PTFE to form a catalyst layer, followed by transferring the catalyst layer alone to the solid electrolyte to form a 3-layer MEA, to which a porous conductive sheet is pressure-bonded to produce an MEA of 5-layer structure.

(4) Later catalyst carrying method: wherein an ink, in which a carbon material not carrying platinum powder has been mixed with a proton conductive material, is coated on a solid electrolyte, a porous conductive sheet or PTFE to form a film, followed by impregnating platinum ions into the solid electrolyte to reduce the ion to precipitate platinum powder in the film, thereby forming a catalyst layer. After the formation of the catalyst layer, MEA is manufactured by the aforementioned methods (1)-(3).

Examples of material that can be used as the fuel for the fuel cell employing the solid electrolyte of the invention include, as anode fuel, hydrogen, alcohols (methanol, isopropanol, ethylene glycol etc.), ethers (dimethylether, dimethoxymethane, trimethoxymethane etc.), formic acid, boron hydride complexes, ascorbic acid and the like. As cathode fuel, oxygen (including oxygen in air), hydrogen peroxide and the like.

For a direct methanol type fuel cell, which is synonymous with a solid polymer type fuel cell, as anode fuel, an aqueous methanol solution with methanol concentration of 3-64% by mass is used. According to the anode reaction formula (CH₃OH+H₂O→CO₂+6H⁺+6e⁻), 1 mol of methanol requires 1 mol of water, wherein methanol concentration at the time corresponds to 64% by mass. A higher methanol concentration leads to such an advantage that mass and volume of a battery including a fuel tank can be made smaller for the same energy capacity. However, a higher methanol concentration tends to result in noteworthy so-called crossover phenomenon, in which methanol passes through the solid electrolyte and reacts with oxygen on the cathode side to decrease voltage, thereby leading to decrease in output power. Therefore, optimal concentration is determined according to methanol diffusivity of a solid electrolyte-used. The cathode reaction formula of a direct methanol type fuel cell is (3/2O₂+6H⁺+6e⁻→H₂O), and oxygen (usually oxygen in air) is used as fuel.

There are 2 ways to supply the aforementioned anode fuel and cathode fuel to respective catalyst layers, that is, (1) a method in which they are subjected to controlled circulation using an auxiliary machine such as a pump (active type), and (2) a method in which no auxiliary machine is used (passive type, in which, for example, liquid fuel is supplied by capillary action or free fall; and gas fuel is supplied by exposing a catalyst layer to air). An active type that can supply high output is preferable.

Generally, single cell voltage of a fuel cell is 1 V or less, therefore, single cells are used in series stacking in accordance with necessary voltage required from load. As for the stacking method, “planar stacking” wherein single cells are aligned on a plane and “bipolar stacking” wherein single cells are stacked via a separator having fuel paths formed on both sides thereof, are used. The former is suitable for a compact fuel cell, because the cathodic pole (air pole) is exposed on the surface, thereby making it easy to take in air and possible to form a thin type stacking. In addition to these, a method is proposed in which, while applying MEMS technology, microfabrication is given to a silicon wafer to form a stacking.

For a fuel cell, various applications are discussed, including transportation use, household use and portable device use. For example, transportation use to which it can be preferably applied includes the car (such as an automobile, a truck, an autobicycle and a personal beagle) and the marine vessel; household use includes the co-generation system, the cleaner and the robot; and portable device use includes the cellular phone, the mobile notebook computer, the electronic still camera, PDA, the video camera, and the handheld gaming device. In addition, it can be used for a portable generator, an outdoor lighting device and the like. Further, it can preferably be used as a power source for the robot for industrial use or household use, or other toys and games. Furthermore, it is useful as a power source for charging a secondary battery or a capacitor mounted on these devices.

### EXAMPLES

Hereinafter, the invention will be described more specifically based on Examples. Material, use amount, percentage, treatment content, treatment procedure and the like represented in Examples below can be arbitrarily changed as long as the change results in no deviation from the intent of the invention. Accordingly, the scope of the invention is not restricted to the specific examples represented below.

In the Example, measurement of ion conductivity and strength, and degradation test were carried out according to following methods.

[Ion Conductivity]

The solid electrolytes was cut out into a circle of 5 mm in diameter, which was set between 2 stainless plates. Then, an ion conductivity at 25° C. and 95% RH was measured by an alternating-current impedance method.

[Strength]

The solid electrolyte was cut out into 2.5 cm×1 cm to be subjected to strength test by tension according to JIS K-7127. Tensile strength at breaking of the sample was recorded as strength thereof. A greater value is better.

[Degradation Test]

To a Teflon® surface-coated metal vessel, 1.0 g of the solid electrolyte and 15 ml of ion-exchanged water were added, which was held at 120° C. for 2 weeks. Then the sample was taken out and measured of ion conductivity by the aforementioned method.

In the example, a fuel cell was manufactured according to the following method, whose characteristics were measured.

[Manufacture of a Fuel Cell]

(1) Manufacture of a Catalyst Film

2 g of platinum-carrying carbon (50% by weight of platinum is carried on Vulcan XC72) and 15 g of a solid electrolyte solution (aqueous 5% N-methylpyrrolidone solution) were mixed and then dispersed by an ultrasonic dispersing device for 30 minutes. The obtained dispersion was coated on carbon paper (thickness 350 μm), then heated and dried, which was cut out into a circle to form a catalyst film.

(2) Manufacture of MEA

The catalyst films obtained above were laminated on both sides of Nafion® 117 so that the coated face contacted to Nafion® 117, and then thermally compression-bonded at 125° C., 3 MPa for 2 minutes to manufacture MEA.

(3) Fuel Cell Characteristics

MEA obtained in (2) was set to a fuel cell shown in FIG. 2, and then hydrogen gas was flown to the anode side opening 15. At that time, air was flown to the cathode side opening 16. A potentiostat was connected between the anode electrode 12 and the cathode electrode 13, and current value at 700 mV was recorded.

### Example 1-1

### Manufacture of a Solid Electrolyte (E-1-1)

Synthesis of PBI was carried out as below according to description on pp 132-133 of Maruzen, Shin Jikken Kagaku Koza (New Experimental Chemistry Course), Kobunshi Kagaku (Polymer Science). 20.20 g of 3,3′-diaminobenzidine and 30.0 g of isophthahlic acid phenyl ester were put in a flask, and then heated to 220° C. and stirred in nitrogen flow. After 30 minutes, it was heated to 260° C., gradually evacuated to attain to as high vacuum as possible. After polymer had solidified satisfactorily, it was heated to 300° C., and heated for additional 3 hours in a vacuum state. After cooling, the polymer was crushed to give powder. The polymer and then a few steel balls were put in a rotary evaporator, which was heated at 250° C. for 5 hours, and additionally at 350° C. for 5 hours with rotation in a high vacuum state. After cooling, the resultant was taken out to give PBI.

The PBI (3 g) synthesized by the above method was dissolved in dimethyl acetamide (DMAc) (60 ml) in a 4-necked round-bottomed flask at room temperature in nitrogen flow. The solution was gradually added with lithium hydride and stirred at 85° C. for 3 hours. Then, 11.7 g of propane sultone having a double bond was added, which was stirred for 24 hours. Then, a large excess of acetone was added to generate a precipitate, which was filtered and taken out, and further washed with acetone and then with 15% hydrochloric acid. The taken out polymer was dried at 40° C. for 24 hours in vacuum to give sulfonated PBI.

The sulfonated PBI electrolyte was dissolved in DMAc so as to give a concentration of 5% by weight. The solution was cast to form a solid electrolyte (E-1-1) in a film shape having a thickness of 40 μm.

The obtained electrolyte film had an ion conductivity of 0.019 S/cm and a tensile strength of 490 kg/cm². A fuel cell was manufactured by the aforementioned method, whose cell characteristics was measured to give a current value of 78 mA.

The solid electrolyte (1.0 g) and ion-exchanged water (15 ml) were put in a Teflon® surface-coated metal vessel and then held at 120° C. for 2 weeks. An ion conductivity and tensile strength of the solid electrolyte, and a current value of a fuel cell manufactured by the aforementioned method were measured and compared with values having been obtained for a sample before the 2-week treatment, to give little lowering.

### Example 1-2

### Manufacture of an Solid Electrolyte (E-1-2)

Polysulfone (11.0 g) and 1,1,2,2-tetrachloroethane (200 ml) were put in a 500 ml three-necked round-bottomed flask, whose inside had been nitrogen-substituted, provided with a reflux condenser having a stirrer, a thermometer and a calcium chloride tube, and stirred at 60° for 1 hour to dissolve polysulfone sufficiently.

Then, chloromethylmethyl ether (ClCH₂OCH₃) (37.5 ml, 4.98×10⁻¹ mol) added with SnCl₄ (0.3 ml, 2.50×10⁻³ mol) was added to the solution of polysulfone and stirred 110° C. for 3 hours under nitrogen substitution to be reacted. Then 3 ml of methanol was added to stop the reaction and left to stand till it became at around room temperature. The solution was then transferred to a beaker, to which 400 ml of methanol was added to precipitate polymer, and then subjected to suction filtration to separate the precipitate from filtrate. The precipitate was added with 200 ml of methanol again to precipitate polymer, which was subjected to suction filtration to separate the precipitate from the filtrate. The precipitate was vacuum-dried to give a polymer.

60% sodium hydride (0.774 g, 1.86×10⁻² mol) was put in a 500 ml three-necked round-bottomed flask, whose inside had been nitrogen-substituted, provided with a reflux condenser having a stirrer, a thermometer and a calcium chloride tube. Then, a solution of a compound: HO—CH₂—CH═CH—SO₃Na (2.98 g, 1.86×10⁻² mol) in dehydrated DMF (35 ml) was added gradually by a dropping funnel, which was stirred sufficiently for 5 minutes. The solution was gradually added with a solution of the synthesized chloromethylated polymer (1 g) in dehydrated DMF (15 ml) by a dropping funnel and stirred at 100° C. for 4 hours under nitrogen substitution to be reacted. Then, 3 ml of methanol was added to stop the reaction, which was left to stand till it became at around room temperature. The solution was then added gradually to 200 ml of methanol to precipitate a polymer, which was separated from filtrate by suction filtration. The precipitate was added with 30 ml of DMF and stirred sufficiently, to which 300 ml of distilled water was gradually added with stirring to precipitate a polymer, which was separated from filtrate by suction filtration. The precipitate was vacuum-dried to give a sulfonated polymer.

The solid electrolyte had an ion conductivity of 0.031 S/cm and a tensile strength of 460 kg/cm². A fuel cell was manufactured by the above-described method and measured of cell properties to give a current value of 87 mA.

In a Teflon® surface-coated metal vessel, the solid electrolyte (1.0 g) and ion-exchanged water (15 ml) were put, which was held at 120° C. for 2 weeks. An ion conductivity and tensile strength of the solid electrolyte, and a current value of a fuel cell manufactured by the aforementioned method were measured and compared with values having been obtained for a sample before the 2-week treatment, to give little lowering.

### Comparative Example 1-1

### Manufacture of a Solid Electrolyte (R-1-1)

12 g of polysulfone and 50 ml of concentrated sulfuric acid were put in a 500 ml three-necked round-bottomed flask, whose inside had been nitrogen-substituted, provided with a reflux condenser having a stirrer, a thermometer and a calcium chloride tube. It was stirred at room temperature overnight in nitrogen flow. To the solution, 20 ml of chlorosulfuric acid was gradually added with stirring using a dropping funnel in nitrogen flow. After the end of dropping, the reaction solution was stirred at 25° C. for 2 hours. Then the reaction solution was gradually dropped in 1 litter of distilled water to separate out sulfonated polysulfone, which was filtered and collected. The collected precipitate was crushed by a mixer, which was subjected to repeated washing with distilled water and suction filtration twice. Then, it was dried at 80° C. under a reduced pressure overnight.

The aforementioned sulfonated polysulfone electrolyte was dissolved in a mixed solvent (1:1) of trichloroethane-dichloroethane so as to give a concentration of 5% by weight. The solution was cast to form a film of 40 μM in thickness. The film (5 cm×5 cm) was dipped in 1 N hydrochloric acid solution (50 ml) for a day to give a solid electrolyte. The solid electrolyte had an ion conductivity of 0.02 S/cm and a tensile strength of 330 kg/cm². Further, a fuel cell was manufactured by the aforementioned method and measured of cell properties. The obtained current value was 72 mA.

The above-described solid electrolyte (1.0 g) and ion-exchanged water (15 ml) were put in a Teflon® surface-coated metal vessel and held at 120° C. for 2 weeks. As the result, the solid electrolyte had observable cleavages in places, and was brittle.

### Comparative Example 1-2

### Manufacture of a Solid Electrolyte (R-1-2)

### Synthesis of 3,3′-dimethyl-4,4′-diaminobiphenyl-6,6′-disulfonic acid sodium (hereinafter, referred to as MBDSA-Na)

3,3′-dimethyl-4,4′-diaminobiphenyl-6,6′-disulfonic acid (hereinafter, referred to as MBDSA) (1-00 g) (2.69 mmol), sodium hydroxide (0.108 g) (2.69 mmol) and deionized water (4.4 g) were mixed and stirred for 1 hour. Then, the solvent was removed, which was dried under a reduced pressure to give 1.0 g of MBDSA-Na.

### Comparative Example 2-1

Polysulfone (12 g) and concentrated sulfuric acid (50 ml) were put in a 500 ml three-necked round-bottomed flask, whose inside had been nitrogen-substituted, provided with a reflux condenser having a stirrer, a thermometer and a calcium chloride tube. It was stirred at room temperature overnight in nitrogen flow. To the solution, chlorosulfuric acid (20 ml) was gradually added using a dropping funnel in nitrogen flow. After the end of dropping, the reaction solution was stirred at 25° C. for 2 hours. Then the reaction solution was gradually dropped in distilled water (1 litter) to separate out sulfonated polysulfone, which was filtered and collected. The collected precipitate was crushed by a mixer, which was subjected to repeated washing with distilled water and suction filtration twice. Then, it was dried at 80° C. under a reduce pressure overnight to give sulfobated polysulfone (a solid electrolyte).

The obtained solid electrolyte was dissolved in a mixed solvent (1:1) of trichloroethane-dichloroethane so as to give a concentration of 5% by weight. The solution was cast to form a film of the solid electrolyte having a thickness of 40 μm. The obtained film (5 cm×5 cm) was dipped in 1 N HCl solution (50 ml) for a day to give a proton conductive film. The obtained proton conductive film had an ion conductivity of 0.02 S/cm and a tensile strength of 330 kg/cm². Further, a catalyst film, MEA and a fuel cell were manufactured by the aforementioned method. The fuel cell was measured of cell properties to give a current value of 72 mA.

The above-described proton conductive film (1.0 g) and ion-exchanged water (15 ml) were put in a Teflon® surface-coated metal vessel and held at 120° C. for 2 weeks. As the result, the proton conductive film had observable cleavages and was brittle.

### Comparative Example 1-2

### (1) Synthesis of 3,3′-dimethyl-4,4′-diaminobiphenyl-6,6′-disulfonic acid sodium (hereinafter, referred to as MBDSA-Na)

3,3′-dimethyl-4,4′-diaminobiphenyl-6,6′-disulfonic acid (hereinafter, referred to as MBDSA) (1.00 g, 2.69 mmol), sodium hydroxide (0.108 g, 2.69 mmol), dehydrated water (4.4.

g) were mixed and stirred for 1 hour. Then, the solvent was removed, which was dried under a reduced pressure to give MBDSA-Na (1.0 g).

The above proton-conductive film (1.0 g) and ion-exchanged water (15 ml) were put in a Teflon® surface-coated metal vessel and held at 120° C. for 2 weeks. As the result, the proton-conductive film had observable cleavages and was brittle.

### Example 2-1

Synthesis of PBI was carried out as below according to description on pp 132-133 of Maruzen, Shin Jikken Kagaku Koza (New Experimental Chemistry Course), Kobunshi Kagaku (Polymer Science). 3,3′-diaminobenzidine (20.20 g) and isophthahlic acid phenyl ester (30.0 g) were put in a flask, and then heated to 220° C. and stirred in nitrogen flow. After 30 minutes, it was heated to 260° C., gradually evacuated to attain to as high vacuum as possible. After polymer had solidified satisfactorily, it was heated to 300° C., and heated for additional 3 hours in a vacuum state. After cooling, the polymer was crushed to give powder. The polymer and then a few steel balls were put in a rotary evaporator, which was heated at 250° C. for 5 hours, and additionally at 350° C. for 5 hours with rotation in a high vacuum state. After cooling, the resultant was taken out to give PBI.

The PBI (3 g) synthesized by the above method was dissolved in DMAc (60 ml) in a 4-necked round-bottomed flask at room temperature in nitrogen flow. The solution was gradually added with lithium hydride and stirred at 85° C. for 3 hours. Then, compound II (9.8 g) shown below was added and stirred for 24 hours. Then, a large excess of acetone was added to generate a precipitate, which was filtered and taken out, and further washed with acetone and then with 15% hydrochloric acid. The taken out polymer was dried at 40° C. for 24 hours in vacuum to give sulfonated PBI (proton conductive material).

The proton conductive material was dissolved in DMAc so as to give a concentration of 5% by weight. The solution was cast to form a proton conductive film having a thickness of 40 μm.

The obtained proton conductive film had an ion conductivity of 0.020 S/cm and a tensile strength of 470 kg/cm². A catalyst film, MEA and a fuel cell were manufactured by the aforementioned method. The fuel cell was measured of cell characteristics to give a current value of 80 mA.

The proton conductive film (1.0 g) and ion-exchanged water (15 ml) were put in a Teflon® surface-coated metal vessel and then held at 120° C. for 2 weeks. An ion conductivity and tensile strength of the proton conductive film, and a current value of a fuel cell including a catalyst film and MEA, all of which were manufactured by the aforementioned method, were measured and compared with values having been obtained for a sample before the 2-week treatment, to give little lowering, respectively.

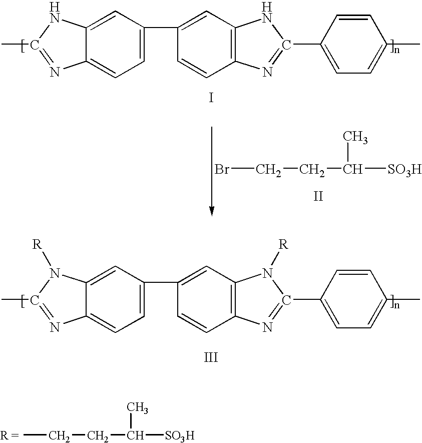

### Example 2-2

Polysulfone (11.0 g) and 1,1,2,2-tetrachloroethane (200 ml) were put in a 500 ml three-necked round-bottomed flask, whose inside had been nitrogen-substituted, provided with a reflux condenser having a stirrer, a thermometer and a calcium chloride tube, and stirred at 60° for 1 hour to dissolve polysulfone sufficiently.

Then, chloromethylmethyl ether (ClCH₂OCH₃) (37.5 ml, 4.98×10⁻¹ mol) added with SnCl₄ (0.3 ml, 2.50×10⁻³ mol) was added to the solution of polysulfone and stirred 110° C. for 3 hours under nitrogen substitution to be reacted. Then methanol (3 ml) was added to stop the reaction and left to stand till it became at around room temperature. The solution was then transferred to a beaker, to which methanol (400 ml) was added to precipitate polymer, and subjected to suction filtration to separate the precipitate from filtrate. To the precipitate, MeOH (200 ml) was added again to precipitate a polymer, which was separated from filtrate by suction filtration. The precipitate was vacuum-dried to give a polymer.

60% sodium hydride (0.774 g, 1.86×10⁻² mol) was put in a 500 ml three-necked round-bottomed flask, whose inside had been nitrogen-substituted, provided with a reflux condenser having a stirrer, a thermometer and a calcium chloride tube. Then, a solution of compound VII (2.98 g, 1.36×10⁻² mol) below in dehydrated dimethyl formamide (DMF) (35 ml) was gradually added by a dropping funnel and stirred sufficiently for 5 minutes, to which a solution of the synthesized chloromethylated polymer (1 g) in dehydrated DMF (15 ml) was gradually added by a dropping funnel, and then stirred at 100° C. for 4 hours in nitrogen flow to be reacted. Then, methanol (3 ml) was added to stop the reaction, which was left to stand till it became at around room temperature. Then, the solution was gradually added to methanol (200 ml) to precipitate a polymer, which was separated from filtrate by suction filtration. The precipitate was added with DMF (30 ml) and stirred sufficiently, which was gradually added with distilled water (300 ml) with stirring to precipitate a polymer, which was separated from filtrate by suction filtration. The filtrate was vacuum-dried to give sulfonated polysulfone (solid electrolyte).

The solid electrolyte was dissolved in a mixed solvent (1:1) of trichloroethane-dichloroethane so as to give a concentration of 5% by weight. The solution was cast to form a solid electrolyte film having a thickness of 40 μm. The obtained solid electrolyte film (5 cm×5 cm) was dipped in a 3% HCl solution (50 ml) for a day to give a proton-conductive film. The obtained proton-conductive film had an ion conductivity of 0.031 S/cm and a tensile strength of 460 kg/cm². A catalyst film, MEA and a fuel cell were manufactured by the aforementioned method. The fuel cell was measured of cell characteristic to give a current value of 87 mA.

The proton-conductive film (1.0 g) and ion-exchanged water (15 ml) were put in a Teflon® surface-coated metal vessel, and held at 120° C. for 2 weeks. An ion conductivity and tensile strength of the proton conductive film, and a current value of a fuel cell including a catalyst film and MEA, all of which were manufactured by the aforementioned method, were measured and compared with values having been obtained for a sample before the 2-week treatment, to give little lowering, respectively.

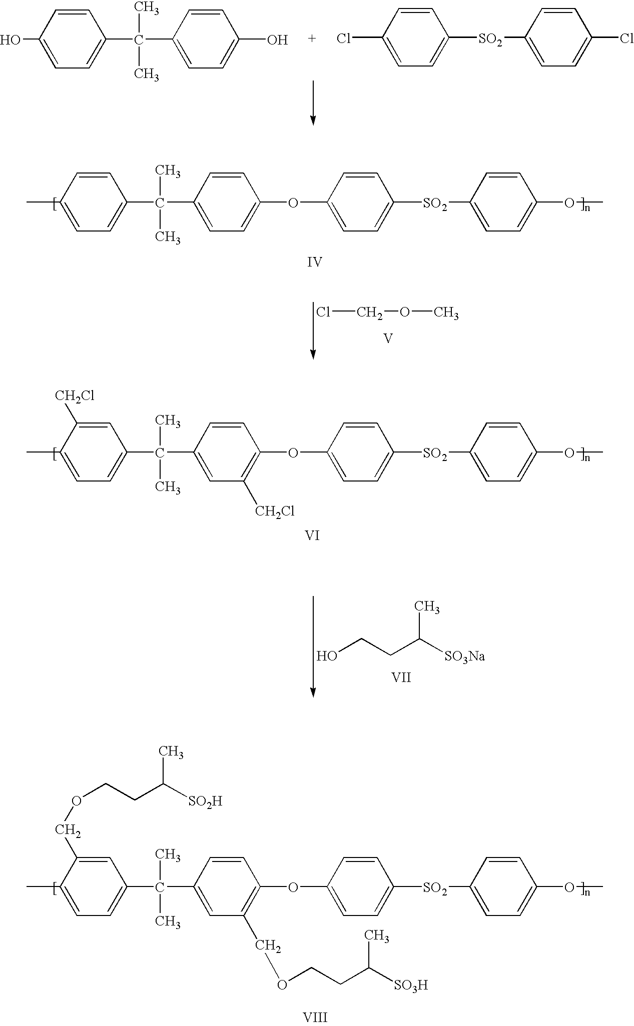

The invention can give a solid electrolyte having an excellent ion conductivity. Further, the solid electrolyte makes it possible to manufacture a more excellent fuel cell.

The present disclosure relates to the subject matter contained in Japanese Patent Application No. 084984/2005 filed on Mar. 23, 2005 and Japanese Patent Application No. 084985/2005 filed on Mar. 23, 2005, which are expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A solid electrolyte comprising an aromatic polymer compound in which an acid residue bonds to an aromatic ring included in the main chain of the compound via a carbon-carbon double bond.

2. The solid electrolyte according to claim 1, wherein the main chain of the aromatic polymer compound comprises at least one recurring structure represented by the following formula (1) or (4):
-R¹¹-X- (1)
-R¹⁴ (4)
wherein each of R¹¹ and R¹⁴ independently represents a group consisting of at least one linking group represented by the following formulae (5)-(24): 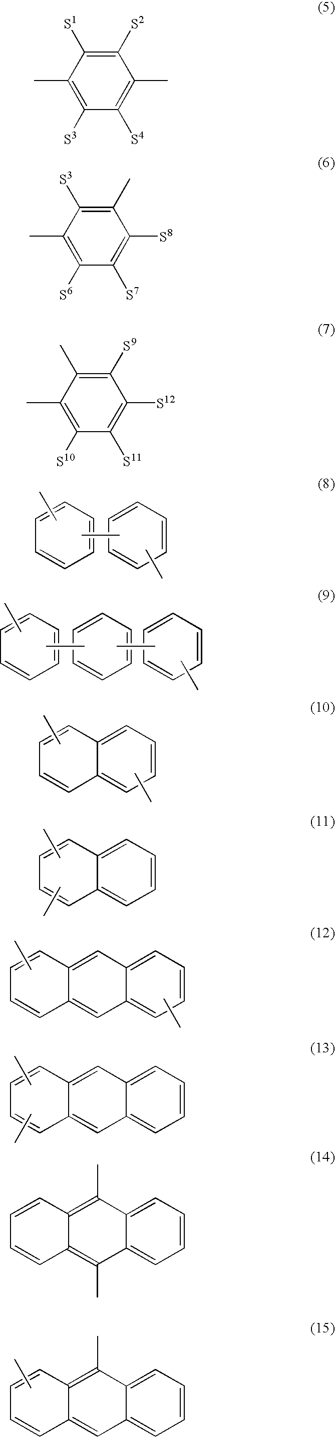 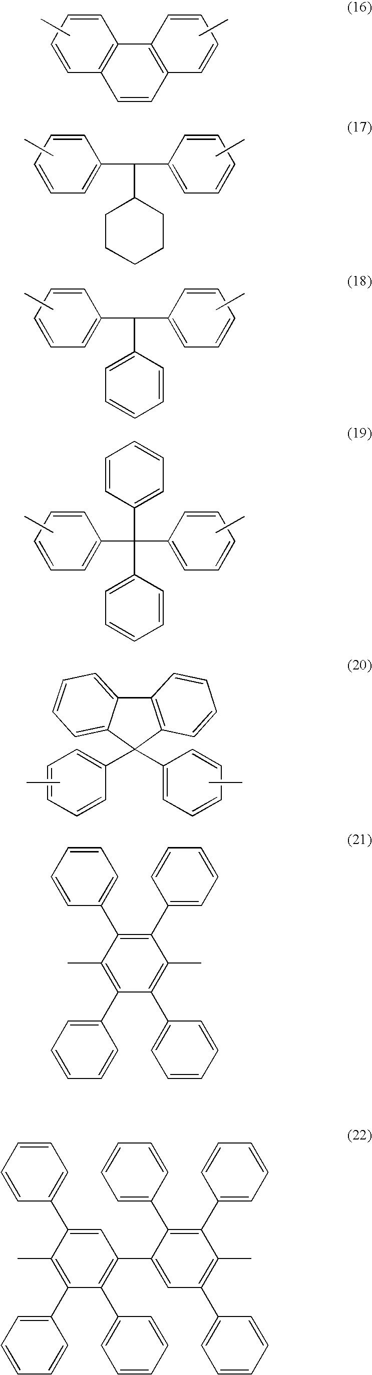 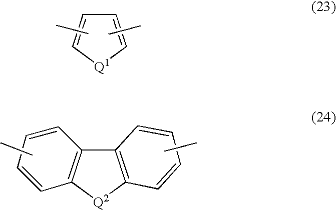
wherein each of S¹-S¹² in (5)-(7) independently represents a hydrogen atom or a substituent, Q¹ in (23) represents —O— or —S—, and Q² in (24) represents —O—, —CH₂—, —CO— or —NH₂—; X represents —C(R²⁵R²⁶)—, —O—, —S—, —CO—, —SO— or —SO₂—; and each of R²⁵ and R²⁶ independently represents a hydrogen atom, an alkyl group, an alkenyl group, an aryl group or a halogen-substituted alkyl group.

3. The solid electrolyte according to claim 1, wherein the aromatic polymer compound is a polyethersulfon-based compound, a polyetherethersulfone-based compound, a polyetheretherketone-based compound, a polyphenylenesulfide-based compound, a polyphenyleneether-based compound, a polysulfone-based compound, a polyetherketone-based compound, a polyimide-based compound or a polyetherimide-based compound.

4. The solid electrolyte according to claim 1, wherein the main chain of the aromatic polymer compound comprises at least one recurring structure represented by any one of the following formulae (2-1)-(2-4): 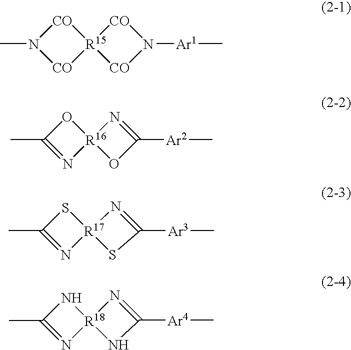
wherein each of R¹⁵-R¹⁸ independently represents a quadrivalent group having 6-36 carbon atoms, and forms a cyclic structure with adjacent 2 bonding groups; and each of Ar¹-Ar⁴ independently represents a divalent group having 6-24 carbon atoms.

5. The solid electrolyte according to claim 1, wherein the main chain of the aromatic polymer compound comprises at least one recurring structure represented by any one of the following formulae (3-1)-(3-5):

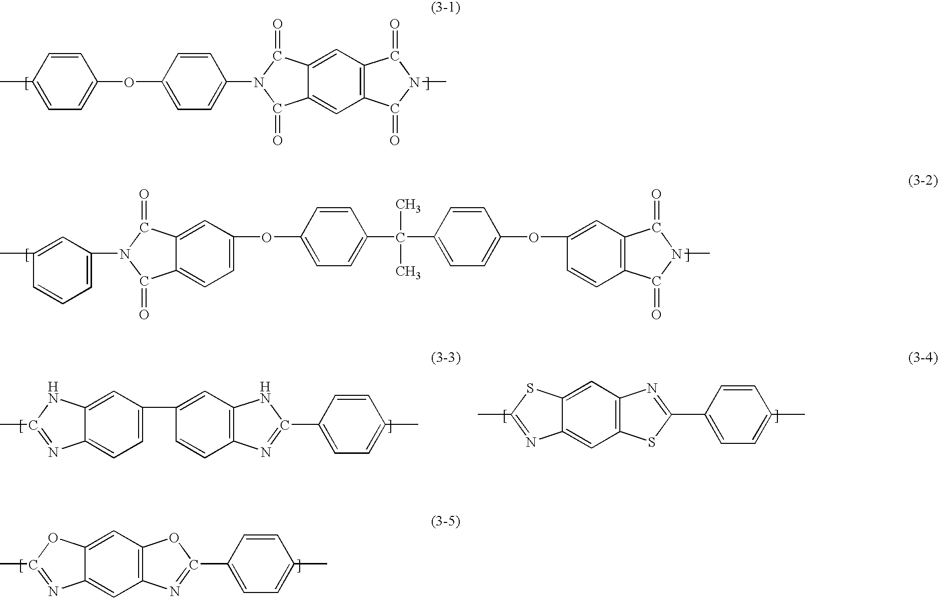

6. The solid electrolyte according to claim 1, wherein the acid residue is a sulfonic acid group.

7. The solid electrolyte according to claim 1, wherein the aromatic polymer compound comprises a side chain represented by the following formula (A-2): 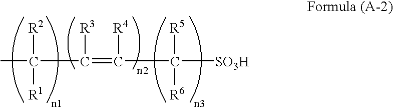
wherein each of R¹-R⁶ independently represents a hydrogen atom or a substituent, and two or more of R¹-R⁶ may bond to each other to form a ring; n1 represents 0 or an integer of 1-20, n2 represents an integer of 1-3, and n3 represents 0 or an integer of 1-10.

8. The solid electrolyte according to claim 1, wherein the aromatic polymer compound comprises a side chain represented by the following formula (A-2): 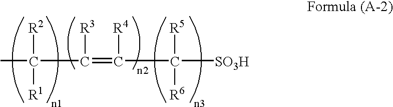
wherein each of R¹-R⁶ independently represents a hydrogen atom or a substituent, and two or more of R¹-R⁶ may bond to each other to form a ring; and n1 represents 0 or an integer of 1-20, n2 represents an integer of 1-3, and n3 represents 0.

9. The solid electrolyte according to claim 1, which is in the form of film.

10. An electrode for a fuel cell comprising the solid electrolyte according to claim 1.

11. A film and electrode assembly comprising a pair of electrodes and the solid electrolyte according to claim 1 sandwiched between the electrodes.

12. A fuel cell comprising the film and electrode assembly according to claim 11.

13. A solid electrolyte comprising an aromatic polymer compound having a main chain including an aromatic ring and a side chain bonding to the aromatic ring, in which a carbon atom at an α position of the side chain is bonded with at least one substituent as well as a sulfonic acid group.

14. The solid electrolyte according to claim 13 wherein the main chain of the aromatic polymer compound comprises at least one recurring structure represented by the following formula (1) or (4):
-R¹¹-X- (1)
-R¹⁴ (4)
wherein each of R¹¹ and R¹⁴ independently represents a group consisting of at least one linking group represented by the following formulae (5)-(24): 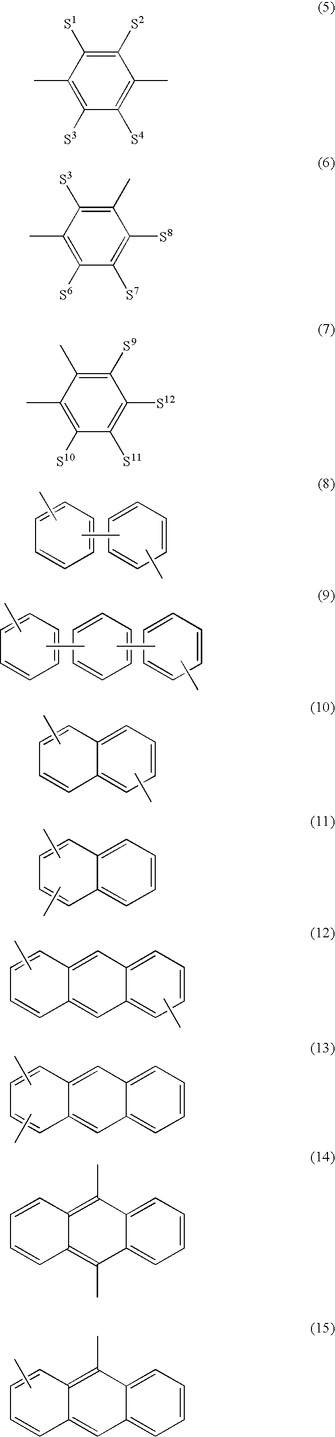 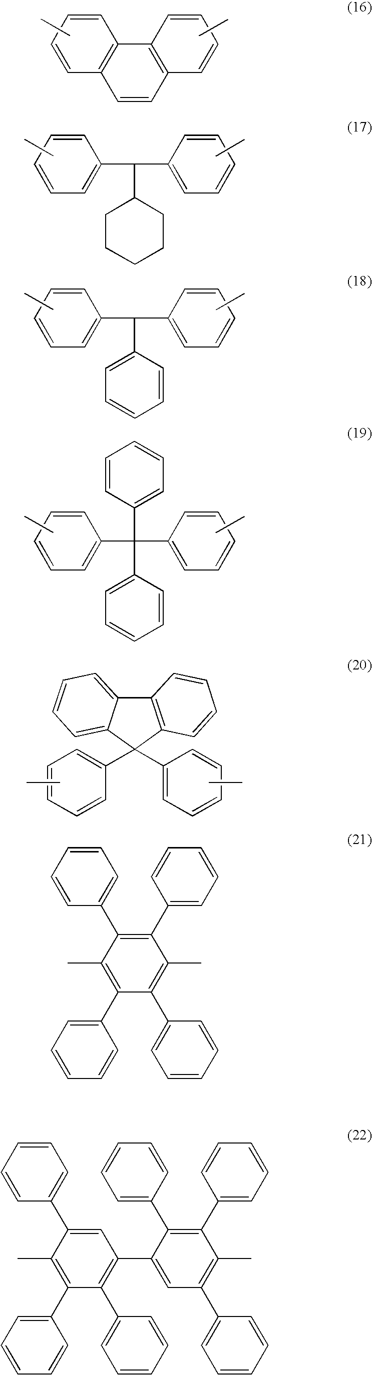 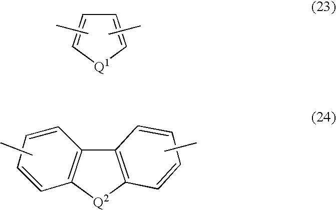
wherein each of S¹-S¹² in (5)-(7) independently represents a hydrogen atom or a substituent, Q¹ in (23) represents —O— or —S—, and Q² in (24) represents —O—, —CH₂—, —CO— or —NH₂—; X represents —C(R²⁵R²⁶)—, —O—, —S—, —CO—, —SO— or —SO₂—; and each of R²⁵ and R²⁶ independently represents a hydrogen atom, an alkyl group, an alkenyl group, an aryl group or a halogen-substituted alkyl group.

15. The solid electrolyte according to claim 13, wherein the aromatic polymer compound is a polyethersulfon-based compound, a polyetherethersulfone-based compound, a polyetheretherketone-based compound, a polyphenylenesulfide-based compound, a polyphenyleneether-based compound, a polysulfone-based compound, a polyetherketone-based compound, a polyimide-based compound or a polyetherimide-based compound.

16. The solid electrolyte according to claim 13, wherein the main chain of the aromatic polymer compound comprises at least one recurring structure represented by any one of the following formulae (2-1)-(2-4): 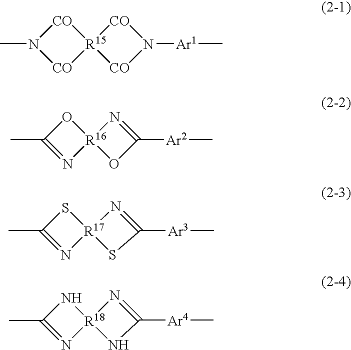
wherein each of R¹⁵-R¹⁶ independently represents a quadrivalent group having 6-36 carbon atoms, and forms a cyclic structure with adjacent 2 bonding groups; and each of Ar¹-Ar⁴ independently represents a divalent group having 6-24 carbon atoms.

17. The solid electrolyte according to claim 13, wherein the main chain of the aromatic polymer compound comprises at least one recurring structure represented by any one of the following formulae (3-1)-(3-5):

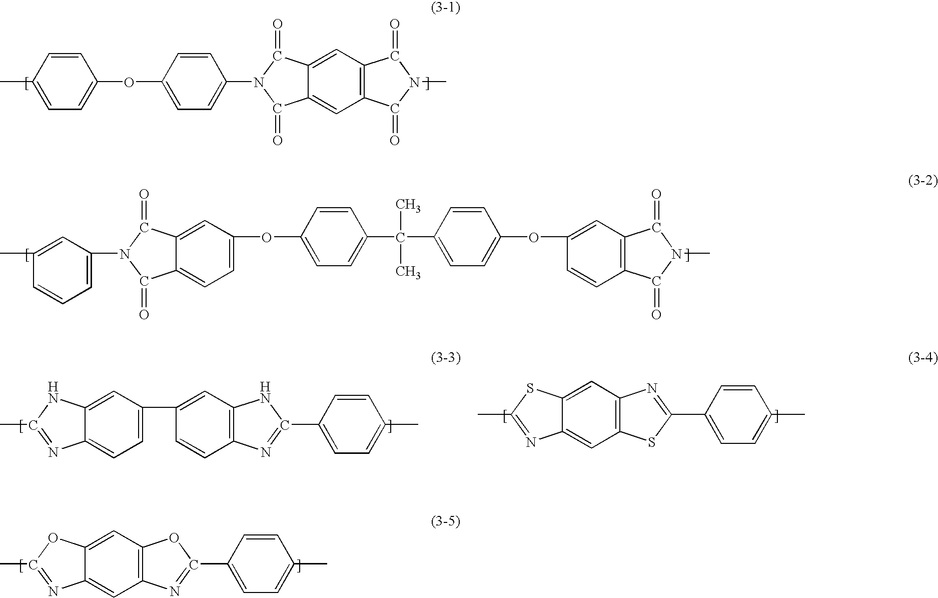

18. The solid electrolyte according to claim 13, wherein the aromatic polymer compound comprises a side chain represented by the following formula (B): 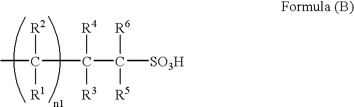
wherein each of R¹-R⁶ independently represents a hydrogen atom or a substituent, provided that at least one of R⁵ and R⁶ represents a substituent; and n1 represents 0 or an integer of 1-20.

19. The solid electrolyte according to claim 13, which is in the form of film.

20. A film and electrode assembly comprising the solid electrolyte according to claim 13.

21. A film and electrode assembly comprising the solid electrolyte according to claim 13 on an electrode.

22. A film and electrode assembly comprising a pair of electrodes and the solid electrolyte according to claim 13 in the form of film arranged between the electrodes.

23. A fuel cell comprising a film and electrode assembly comprising the solid electrolyte according to claim 13 on the electrode.

24. A method for producing the solid electrolyte according to claim 13, which comprises introducing a sulfonic acid group through a reaction using a halogenated alkane.
